(19) United States
(12) Patent Application Publication
(10) Pub. No.: US 2003/0018895 A1
(43) Pub. Date: Jan. 23, 2003

(54) Processes and systems for enabling secure and controlled distribution and use of information

(76) Inventor: Gregg B. Morrison, Duluth, GA (US)

Correspondence Address: POWELL, GOLDSTEIN, FRAZER & MURPHY LLP, P.O. BOX 97233, WASHINGTON, DC, 20090-7223, US

(21) Appl. No.: 09/773,487

(22) Filed: Feb. 2, 2001

(51) Int. Cl. H04L 9/00

(52) U.S. Cl. 713/176

(57) ABSTRACT

Processes and systems are disclosed that use unique “forensic” identifiers to securely deliver and render digital information. The identifiers are produced using information that is capable of identifying specific devices that are to be employed in rendering said information, and may arise from characteristics of the device, its operation or its environment. Because the forensic identifiers can be created from an evaluation of the device or environment in which the information is to be rendered, including at the time of such rendering, the invention does not require that pre-created keys be transferred or handled along with the information to be secured. This generally provides for a greater degree of security than can be realized under prior art models for security. In one embodiment, the invention concerns the use of information unique to a device or a class of devices that will be used to “render” the information (i.e., to translate the digital data into its intended form such as music, images or video). In another embodiment, the identifier is placed in the environment in which such devices are to operate, including, for example, in the electrical supply of a building or region. The identifier —a forensic identifier—is used in authentication processes when an attempt is made to transfer, access or render the digital information. Upon a successful authentication process, the requester will be allowed to access or render the digital information.

The present invention relates generally to the protection of information using forensic identifiers. More particularly, the present invention relates to processes and systems for enabling the secure and controlled distribution and use of data.

### BACKGROUND OF THE INVENTION AND RELATED ART STATEMENT

The advent of new means for storing and distributing digital information has created new security problems. Most of these delivery mechanisms make the distribution of digital content quite inexpensive and simple, which raises significant concerns for piracy or other unauthorized uses of the digital information. And because each copy of a digital information product can be replicated perfectly without replicative fading, there are no inherent barriers to misappropriation of the value of creative works and data when in a digital form.

As a consequence, the industries involved in providing their products in a digital format are usually plagued not only by fierce competition within their own ranks, but also by unsavory predatory practices from those outside of the digital community. Among the most threatening of these practices is that of piracy involving the unauthorized copying of digital data. Piracy is alive and well today and is made more prolific in this Internet age. For example, the Napster Internet portal, where users swap or download copies of protected works, has resulted in a substantial problem for the recording industry. Unauthorized copies cost the various industries billions of dollars in lost annual revenue. Since a pirate has no development costs and substantially less overhead than the author or creator of the pirated work, pirated data usually sells at prices considerably below that of the manufacturer or sells for nothing at all. In both instances, the manufacturer loses a potential sale but the recipient of the pirated copy has benefited without providing any compensation for the creator and the businesses that make that information product possible. With such ease of copying digital data along with the often large discrepancy between the price of unauthorized and authorized computer software, a substantial and continuing black market in illegally-copied software has been created.

Digital data, particularly software distributed on magnetic or optical media, can be readily copied. In the absence of some form of protection, a software package from an authorized dealer may be copied numerous times onto to one or more computer systems. While, in theory, copyright laws protect software developers from unauthorized duplication of their wares, it is often difficult, impractical, and costly for developers to assert their copyrights against a small company or an individual who makes only a few copies. License agreements also have little value in preventing unauthorized copying by small companies or the occasional and habitual individual infringer. In many instances, it is not possible for the software developer to discern the identity of an unauthorized user of its software. For example, it is not uncommon for several individuals to combine their resources to purchase one software program and then make a number of copies for use by each of them on their own personal computers. When the consumer is faced with a relatively low risk of being detected and prosecuted for illicitly copying software, the disincentive in passing along unauthorized copies to friends and acquaintances is greatly reduced.

Various technology-based solutions have been proposed and enacted to minimize the problems of software piracy. In general, these copy protection technologies can be broadly characterized as involving four basic strategies which include “access limitation,” “copy detection,” “duplication limitation” and “copy inactivation.”

A. Access Limitation

“Access limitation” techniques prohibit access to programs installed on a computer's hard or fixed drive such that data contained in the program, and the program itself, cannot be copied without the tacit approval of the authorized licensee. Such access-limiting techniques include hardware such as the mechanical key and lock system of stand-alone computers that requires that the lock be in the “on” position to enable the stand-alone system to operate.

Another commonly used access limitation scheme employs the use of an authorization code, such as a password or key number, which must be obtained from the software supplier and entered when using the software. If the password or code is not entered, the program will not be enabled.

The problem with all access-limiting techniques is that such techniques only work if the licensee of the product vigilantly protects access to the program. This is often not the case, because very frequently it is the licensee who is most willing to allow program access and duplication. A hardware or software key or a code or password can readily be shared with others, permitting them to run the program on their own computers.

B. Copy Protection

Another type of technique used to dissuade unauthorized coping is “copy detection” which has as its primary goal the differentiation of illicit copies from the authorized original. One copy detection scheme involves the destruction, often by laser, of a particular sector on an authorized disk during manufacture. The authorized disk remains operable as upon invocation the sector is verified as unwritable and execution is continued. A copy of such disk, however, easily can be distinguished from the authorized disk since it lacks the obliterated sector.

One of the most widely employed copy detection schemes involves the practice of placing serial numbers in authorized software. Such practice permits the tracing of unauthorized copies to the person to whom the authorized software was originally sold. Another approach is to require the authorized user, upon the first use of the software, to input the user's name which is stored in the software's code such that the user's name will appear on every subsequent initialization screen. These practices are intended to discourage licensed users from allowing their software to be reproduced, knowing that they will be identified in all copies of the work.

Copy detection systems alone do little to dissuade unauthorized copying as the software producer is unlikely to know when the software is illegally copied. External enforcement must be employed to track down and determine who is in possession of an illicit copy. Further, programs exist which permit serial numbers and names located in application programs to be located and erased. In an attempt to foil erasure of such information, one copy detection technique scatters the serial numbers and names in different sectors of the program storage disk and hides the identifying information in the format. Because of the scattered program, the entire disk must be copied to ensure that all portions of the program are copied. In the process, the identifying information is also copied. Such an approach, while making it more difficult to erase identifying information, does not overcome the need for external enforcement to prevent further illicit copying.

C. Duplication Limitation

Another technique used to dissuade unauthorized copying is “duplication limitation” which includes numerous approaches aimed at restricting the number of copies which can be made from a single software package. Duplication limitation may be undertaken by placing restrictions within the computer program which either completely preclude copying or permit only a limited number of copies to be made. Such approach may employ a counter, located in the software, which allows a predetermined number of “starts” for a host program before destroying the program. For example, software packages have been designed such that, after one copy has been made, certain key features, or modules, of the package are obliterated to the extent that further copying is prevented.

Another duplication limitation technique takes advantage of the hardware timer and are thus “date-dependent.” Such programs are designed to match their ending calendar date with that of the hardware timer and to prevent access a function if the ending calendar date has expired.

A relatively sophisticated duplication limitation scheme which has been employed in the art involves the use of a so-called “parasite” instruction set. This technique requires that a parasite be introduced each time the software program is stopped. The parasite changes one byte in the program in a predetermined manner after each stop. The parasite introduction commands are located in a form which is normally not able to be copied. Generally, also specified in the format is a “parasite killer” which restores altered bytes to their original conditions.

Duplication limitation approaches may be overcome by unconventional but nevertheless available programs which reproduce virtually each and every bit that is recorded in the original software package. Duplication limitation approaches further suffer from the disadvantage that they do not allow, or at least severely limit, legitimate backup copies to be made for archival purposes. Programs depending on the clock date can be easily overcome by advancing the ending calendar date in the programs or altering the date in the hardware timer. Parasite techniques can be overcome by replicating the “parasite killer” such that it can be used to restore altered bytes to their original conditions in the unauthorized copies.

D. Copy Invalidation

Another technique designed to reduce piracy is “copy inactivation” which includes a host of approaches aimed at rendering illicit copies entirely useless or less than useful.

One copy inactivation technique involves insertion into the software artifacts whose locations are randomly determined when the software is initially placed on magnetic medium, such as a diskette, and which can only be reproduced under the original copying conditions. When illegal copying is attempted, the artifacts are obliterated and their absence is detected by a process in the software which reacts by altering the software program such that the program becomes un-executable.

Copy inactivation also has been effected by providing with the software package recorded on the original diskette a so-called “boot-strap” program which, when executed, indicates that no further data is recorded. Thus when attempts to copy the original disk are made, the boot-strap program is copied also, but in accordance with typical copying routines, the computer system is deceived into recognizing that no other data is available to be copied. The copied program thus becomes useless.

Copy inactivation schemes may also take into account certain unique physical characteristics of the original software disk. For example, the sectors of original software packages are normally in alignment. A characteristic of this alignment is generally not carried over when the disk is copied. Thus execution of a software program may be made dependent upon detecting the alignment-associated characteristic of the original software package.

As with duplication limitation techniques, copy-inactivation techniques typically do not permit back-up copies of a hard-drive to be made. Some copy-inactivation schemes further restrict use of the software to the medium upon which the software originally was provided. Boot-strap schemes may be overcome by recognizing and obliterating the boot-strap program before copying. Copy protection schemes that incorporate some copy-preventing feature in the purchased software package which can be detected by a standard disk drive, but which cannot be reproduced by the drive, have not been found to be very effective as the usual mechanical tolerances found in disk drives minimizes the efficacy of such schemes.

One disadvantage attendant to typical access limitation, copy detection, duplication limitation and copy inactivation schemes is that they do not provide a means for preventing an authorized software program from being used by another individual on a different computer. Several proposals have been made to rectify this deficit.

U.S. Pat. No. 4,866,769 to Karp discloses a hardware-based process that embeds a specific identity number in a computer's ROM (Read-Only-Memory) chips. It also uses encryption to achieve this process. The process of Karp uses random numbers to identify a CPU in one embodiment.

U.S. Pat. No. 5,113,518 to Durst, Jr. et al. discloses a process and system for preventing unauthorized use of software. The invention checks the non-system specific features of a PC and “stores” the values (as a “signature”) on the system, specifically, on the hard drive. However, this system arguable is imperfect as all that is needed is one copy of the generic “signature” for each common class of PC and the software will be unable to validly authenticate the machine. Also, if the user ever upgrades the system, the system will not return correct values when authentication is performed.

U.S. Pat. No. 5,337,357 to Chou et al. discloses a process of software distribution protection. This invention requires an accessible (but “unique”) number with an optional random factor to generate a first key, which the user sends to a processing center. The processing center then creates a second key which is returned to the user. If the two keys are combinable through some algorithm, it generates a decryption key that allows the user to purchase the selected program(s).

U.S. Pat. No. 5,652,793 to Priem et al. discloses a hardware encoding circuit which generates a code value unique to a particular computer. The device requires hardware manufacturers to embed numbers in chips that can only be read by an encoding circuit. The stored password is checked each time the application program is run and generates an error signal if the stored password and the verification value do not match.

U.S. Pat. No. 5,745,568 to O'Connor et al. discloses a process of securing CD-ROM data for retrieval by a machine. This invention requires a custom computer configuration to be specified and built. A custom-written CD-ROM is manufactured with software that contains an embedded system ID, so the CD can be used initially to install the software on the system.

U.S. Pat. No. 6,006,190 to Baena-Amaiz et al. discloses a process for enforcing computer software licenses. The invention is a dongle-type invention and requires a piece of hardware to decrypt the program when it is executed. The patent details use with only DOS and Windows applications. The invention is implemented with an encryption shell in one embodiment.

U.S. Pat. No. 6,148,407 to Aucsmith discloses a process and apparatus for producing computer platform fingerprints. This invention uses encryption of a key on a system. An application decrypts this key and determines if it is “similar enough” to the expected system for operation to commence. If the application cannot significantly determine the platform identity, it “looks-up” the identity from a location in the installed operating system on the computer. The storage of the “fingerprint” in a file on the computer (e.g., in a “DLL” file) renders this process relatively easy to circumvent.

U.S. Pat. No. 6,170,060 to Mott et al. discloses a process and apparatus for targeting a digital information playback device. The invention embeds a number in the digital information (file) that has to match either a specific playback device ID or a playback group ID, which is then used to decrypt the data on a second-by-second basis. The invention requires embedding a number in the playback device, which is a hardware-based encryption process.

While arguably providing some improvement in the field of electronic data security, the above-described advances do not meet all security needs. Accordingly, an improved process and method of electronic data security remains wanting.

### OBJECT AND SUMMARY OF THE INVENTION

Generally speaking, the present invention concerns processes and systems that use unique “forensic” identifiers to securely deliver and render digital information. The identifiers are produced using information that is capable of identifying specific devices that are to be employed in rendering said information, and may arise from characteristics of the device, its operation or its environment. Because the forensic identifiers can be created from an evaluation of the device or environment in which the information is to be rendered, including at the time of such rendering, the invention does not require that pre-created keys be transferred or handled along with the information to be secured. This generally provides for a greater degree of security than can be realized under prior art models for security.

Forensic identifiers are generated pursuant to the invention from the inherent characteristics of an object. These can be any one or any combination of:

Actual digital information generated by or extracted from the device or object.

Calculated information about the device or object based on rules or algorithms.

A digitized analog value generated by or otherwise obtained from the specific device or object.

A direct internal or external measurement, which is converted into a digital format.

One or more of these parameters are combined into a digital Identity with a sufficient number of bits to uniquely identify the singular device or object to the level necessary for the security required. Once an object or device is thus identified, it can be separately identified from any other object or device through digital means.

Accordingly, one object of the invention is to provide more reliable, effective and easier to administer systems and processes for securing digital information. Thus, in one embodiment, the invention concerns the use of information unique to a device or a class of devices that will be used to “render” the information (i.e., to translate the digital data into its intended form such as music, images or video). In another embodiment, the identifier is placed in the environment in which such devices are to operate, including, for example, in the electrical supply of a building or region. The identifier—a forensic identifier—is used in authentication processes when an attempt is made to transfer, access or render the digital information. Upon a successful authentication process, the requestor will be allowed to access or render the digital information.

The devices that can be used as a source of information in the invention may include any type of physical device that can render information, including general purpose computers, special purpose computers, digital audio or audiovisual rendering devices (e.g., MP3 players, DVD or CD players). In addition, devices that render “analog” information sources (e.g., cassette players, motion picture projectors) can be used in the invention, either in their native form, or modified to add components that enable the invention to be implemented using such devices. Finally, devices that are to be used within specified environments which have been secured via the invention include virtually any device that can be employed to render information.

In one general embodiment, the invention concerns processes and systems that will secure digital information using information derived from devices that are employed to render the information to be secured. The forensic identifier in this context is produced using information that is associated in a permanent manner to the physical device or which concern functional attributes of the device. More preferably, the forensic identifier will be produced using information that is permanently associated with specific physical components that are found in the device. Depending on the degree of security desired, forensic identifiers can be produced that uniquely identify a single specific device or which identify a class of devices that share a commonly identified component. The information associated with such components is used to produce the forensic identifier and may be obtained by polling or evaluating the device prior to or during the process of rendering the information. The assessment may include evaluation of attributes of one or more components in the device, a measurement of one or more operational aspects of one or more components in the device, or any combination therein. The information is then used to produce a unique identifier that can be used by mathematical or other techniques to verify the identity of the device or class of devices pursuant to a security model.

In a second general embodiment of the invention, the information that is to be used to produce the forensic identifier will be introduced into the environment where the device that is to render the information is to operate. In this second general embodiment, the identifier will comprise arbitrarily or specifically defined information that can be used to produce the forensic identifier. The information may be introduced into the environment by way of encoding the information or a forensic identifier produced using such information into an electrical, radio or other signal that can be evaluated by the device or by a component or element added to the device.

The forensic identity as envisioned in this invention will be produced using the information associated with the device or its operating environment. More particularly, forensic identifiers pursuant to this invention will comprise binary keys suitable for use in generally known algorithms for authentication or for encoding of data. The binary keys as envisioned in the invention may comprise any suitable key length (e.g., 16, 32, 64, 128, 256, 512, 1024 or higher). The binary keys may be produced by any procedure that can use numeric, alphanumeric, or otherwise coded information.

In a number of embodiments of the invention, the processes and systems will employ as the rendering device a general purpose computer. The computer may be configured through software to be capable of rendering any of a multitude of types of data, including but not limited to audio, audiovisual, image, textual, executable program files for software or other types of information. The computer may also be used in the context of securing information that comprises software to be installed and used on said computer.

Characteristics of numerous components found in a general purpose computer may be used in the invention, such as the CPU, the hard drive, the microprocessor(s), peripheral cards, the motherboard, and circuits associated with the computer. The permanently associated information for such components may include operational aspects of the component (e.g., speed) or attributes permanently associated with such components (e.g., serial number, physical properties).

Other devices may also be used in the invention. These include devices that render information stored on optical media, such as CD players, DVD players, videodisc players and the like. Similarly, the invention may be implemented on or using devices that project visual images, either in digital or “analog” (i.e., encoded on audio or videotape) form. In the latter example, the devices may include video projectors, motion picture projectors, cassette players, digital video projectors and the like. Where devices rely on analog sources of information (e.g,. encoded on video or audio tape), the invention may also incorporate additional components added to the device to enable the evaluation of digital information used in a security context.

The forensic identifiers of the present invention may be employed in a wide variety of processes.

One general benefit of the invention is that processes for security based on utilization of binary authentication keys and algorithms based upon such keys can be implemented without many of the complications and difficulties associated with current public key infrastructure or key-based solutions. The benefit is the result of the capacity of the present invention to “recreate” the key using attributes of the device or system that is being used to render or use the information that is being secured. Thus, the device that uses the information will be polled or assessed to collect information that will be used to produce the key against which authentication will be assessed. This feature of the invention permits the use of security concepts and processes that vastly simplify the task of maintaining the security and integrity of the information used to perform the authentication underlying various security processes.

In a number of embodiments, the digital information to be secured is to be used on a computer, and may comprise data used in the operation of the computer (e.g., application program software, operating system software, drivers or the like). In such embodiments, the forensic identifier may be used to secure the data by preventing its use by a program executing on the computer. In other embodiments, the data will comprise files needed by the computer to execute a computer program or operating system. In such an embodiment, the forensic identifier will be used by the computer system to prevent the installation, launching or operation of the computer program or operating system. Thus, for example, the invention will comprise use of the forensic identifier to prevent the installation of the files needed to operate a computer program if there is not a satisfactory authentication result. In another example, the invention will prevent the operation of a computer program, either by preventing the continued operation of the program or optionally with a temporary or permanent disabling of the files needed to enable the computer program to function, all of which occur if an invalid authentication result is provided. In another example, the invention will not permit the execution of the computer program in a manner that would be permitted if a valid authentication result had been provided (e.g., the program will run in a “trial” mode with certain functions or capabilities disabled). The interference in execution of the computer program may be implemented by preventing the initial operation of the computer program, by termination of the program after initial operation or by termination of the operation of the program at a later point in time.

In another embodiment, the invention comprises use of the forensic identifier to prevent the unauthorized installation or execution of a computer program other than on a specific computer system. Such an embodiment will be particularly well suited to the secure distribution of software purchased “off the shelf” (i.e., without prior interactions between the purchaser and the vendor), and wherein the installation files for the software are located on computer readable medium. In such an embodiment, a user will wish to install the software on their computer in order for the software to operate. The software installation procedure incorporates authentication procedures for securing the information before installation is permitted by a user. During such process, the installation software will probe the computer for information unique to that computer. Once the installation procedure has obtained this information, it will produce the forensic identifier and associate it with the software program to be stored on the computer. Each time that the installed software is initiated by user, it will perform an authentication process. During such process, the software will probe the system, reproduce the forensic identifier and perform the authentication assessment using such information in relation to the forensic identifier associated with the computer program as installed. Upon a positive result, the software will then execute and be made available to the requester.

In another embodiment of the invention, processes are described that enable the secure distribution of data for rendering on specific devices. In this embodiment, the distribution may be effected by conventional physical transfers (e.g., data on an optically readable medium) or by online transfers. In particular, the embodiment is implemented by a first transfer of data obtained from an evaluation of the device that is to render the information to be transferred, followed by creation of the forensic identifier using said information, followed optionally by an encoding of the data using the forensic identifier, followed by a transfer of the data to be rendered to a location where the device that is to render the data may access said data, followed by the rendering of the data after an authentication step provides a positive authorization to render said data. The data to be rendered in this embodiment may be encoded in a form that may only be decoded in conjunction with the forensic identifier created using the information derived from the device that is to render said data. Alternatively or in conjunction with this embodiment, the device that is to render the data cannot render said data absent a positive authentication result. The data may comprise a digital representation of audio, audiovisual, image, textual or other form of content. The data may also comprise a computer program to be installed and/or executed on a specific computer. The devices that may be employed in this embodiment of the invention include general purpose computers configured to render the particular type of data (e.g., an MP3 player program executing on the computer, a motion picture rendering program that uses DVD encoded information, etc.), or a special purpose computer or device that renders such data (e.g., a CD player, a DVD player, a videogame device, a videodisc player, etc.).

In another embodiment of the invention, processes are described that enable the secure rendering of video files downloaded onto devices including computers or set top boxes for viewing purposes. In one embodiment of this invention, a user purchases the desired movie through the set top box. The process begins by first probing the set top box for information needed to generate a forensic identifier. Once this information is obtained and transferred to the location where the information to be delivered resides, a key is produced using the information and associated with the file comprising the video. After the file has been transferred, an authentication procedure is executed on the set top box or computer which recreates the forensic identifier at the site of the rendering device, and compares the forensic identifier to that associated with the data file. An authentication procedure will be performed each time the movie is requested to be shown. Optionally, the rendering device will use the forensic identifier to decode the data comprising the audiovisual work as it is being rendered (e.g., by preventing the rendering of the data if an invalid authentication result is found). Optionally, a counter may be associated with the forensic identifier which limits the number of forensic validations, which in turn will limit the number of times the rendering device will render the data to predetermined number. Optionally, a date and time value also may be associated with the forensic identifier which limits the period of time that the forensic identifier remains valid for the data to be rendered, which limits the period of time that the rendering device will render the data.

In another embodiment of the invention, processes are described that enable the secure transfer of files over a communication network to another device. The process prevents individuals from gaining access to or using the data that is transferred unless they also possess the device that has been authorized to receive and use said data. In this embodiment, the forensic identifier is produced using information associated with the device that is to receive the data. The identifier is then transferred to the sender prior to the transfer of the data and associated with the digital information to be transferred. The data is optionally segmented into packets to facilitate the transfer of said information. Either in the intact form or as segmented, the data is encoded using a suitable algorithm using the forensic identifier, and once received by the destination device, is decoded using the identifier which is created at that point by an evaluation of the receiving device. Procedures are described herein that illustrate encoding processes for such data suitable for use in this embodiment. Using this embodiment, data may be transferred securely over a wire-based channel, phone-based channel, a wireless channel, an optical channel, or a network, including over the Internet, in a form compatible with packet transmission networks and protocols.

In another embodiment of the invention, processes are described to securely transfer data associated with digital video. One real world example is data representing motion pictures. Almost each and every week, newly released or not-so-new motion pictures arrive at theaters around the world. However, the process is fraught with the potential for fraud. For example, multiple theaters can play the picture at multiple locations on different projectors without having to pay for multiple copies of the film. With the present invention, a unique forensic identifier is associated in a permanent fashion with the data comprising the motion picture or a film on which said motion picture is based, prior to the theaters receiving said motion picture. The forensic identifier is produced according to the invention using information obtained from a specifically authorized theater and projector. Prior to each request by the theater to play the movie, the invention performs an authentication process to ensure that the projector is authorized to display the movie.

The embodiments described above are not limiting in the scope of the invention, and will be further illustrated by way of an additional description below.

### BRIEF DESCRIPTION OF THE DRAWINGS

These and other features and advantages provided in accordance with this invention may be better and more completely understood by referring to the following detailed description of exemplary preferred embodiments in conjunction with the drawings, of which:

FIG. 1 is a schematic of a lock system according to the present invention;

FIG. 2 is a schematic of a communication system for operation with the lock system of FIG. 1;

FIG. 3 is a schematic of a system incorporating both the lock system of FIG. 1 and the communication system of FIG. 2;

FIG. 4 is a diagrammatic illustration of a preferred embodiment of the present invention for protecting data;

FIG. 5 is a plan view of a diskette illustrating the typical composition of a computer-readable medium;

FIG. 6 is a plan view of a portion of the diskette of FIG. 5 but particularly illustrating a method of modifying the magnetization of the diskette by laser according to the present invention;

FIG. 7 is a plan view of the major portion of an optically-readable medium illustrating the present security in the form of optically-readable data stored thereon;

FIG. 8a is a view of a portion of the optically-readable medium of FIG. 7 illustrating the location where a unique identifier may be placed according to the present invention;

FIG. 8b is a raised elevational view of a standard configuration of data physically positioned on converted optically-readable media;

FIG. 8c is a raised elevated view of a configuration of data physically positioned on optically-readable media according to the present invention;

FIG. 9 is a view of a portion of the optically-readable medium of FIG. 7 having a pre-programmed identifying chip operatively associated therewith;

FIG. 10 is a view of a portion of the optically-readable medium of FIG. 7 relative to a co-operating media-driven hub according to an alternate embodiment of the preferred invention;

FIG. 11 is substantially a side view of a portion of the optically-readable media of FIG. 7 with a blown-up, edge-on view of the code-containing portion of the media associated therewith;

FIG. 12 is a diagrammatic view of a projector security embodiment of the present invention;

FIG. 13 is a side-elevational view of a system for prohibiting replication of visualizable media; and

FIG. 14 is a side-elevational view of a system for limiting use of a visualizable media to a specified projection device.

### DETAILED DESCRIPTION OF THE PREFERRED EMBODIMENTS

As summarized above, the invention concerns processes and systems that use forensic identifiers produced from physical devices that are to render information that is to be secured. What follows herein are examples that illustrate specific embodiments and applications of the invention.

A number of embodiments pursuant to the invention concern processes and systems implemented on general purpose computers. In such embodiments, computers configured through software may function as the “rendering” environment (i.e., the computer is the device that translates the data into some other form, such as video, audio, image, text or executable file), the source of the forensic identifier or both.

Computers provide a plethora of sources of information for production of forensic identifiers. General purpose computers are comprised of a number of components that provide operational or static identifying characteristics. These characteristics are, generally speaking, permanent or at least consistent during the life of the component. Table I provides examples of such characteristics that can be used as a source of information for production of forensic identifiers. The components screened or probed during the installation process are ones which contain information unique to that device or to a class of devices. The computer as a rendering device offers a view in that certain components act as good indicators for the identification of a particular device to be achieved. Table 1 below offers a non-exhaustive list of components on a computer that act as good indicators for usable unique information.

TABLE 1
Source of Information in General Purpose Computers

| Value | Hardware Item | Bits Used | Identifier Notes |
|---|---|---|---|
| 10 | BIOS Manufacturer Name checksum | 16 | BIOS manufacturer specific (very generic) |
| 14 | BIOS Checksum | 16 | Specific to installed BIOS and Version (generic) |
| 18 | Diagnostic Cylinder Number | 16 | Generic to this model drive (and others) |
| 18 | Sector of Drive 0 Partition 1 Directory | 16 | Generic to this model drive (and others) |
| 18 | True-Capacity Sector Count | 32 | Generic to this model drive (and others) |
| 18 | ROM Areas in Use | 4 | Number of installed ROMs on system |
| 18 | VAE On Card | 1 | Video Card Present |
| 21 | EBIOS present | 1 | Late Model System with Huge drive support |
| 21 | PCI System | 1 | PCI Cards can be added to Identifier |
| 24 | Dram Refresh Count | 16 | Quite specific to this BIOS and System board |
| 27 | VAE Onboard | 1 | Video on System Board |
| 33 | VAE Port access time | 4 | 2 microsecond units - On Board if installed, else Card |
| 38 | Speed Index | 16 | Quite specific to one system board and architecture |
| 55 | Hard Drive Defect Map CRC | 16 | Quite specific to one drive |
| 55 to 72 | CMOS Areas | 8 to 256 | Depends on CMOS and BIOS - skipping generic locations |
| 99+ | True Drive Serial Number | 32 | ATA data CRC-32 Very specific to this individual drive |
| 99++ | ATA Device Internal Identity | 128 to 4096 | Manufactured Into Hard Drives - includes a serial number |

A brief summary of each of these component information sources is provided below. Each of these component information sources shares the characteristic of being a hardware-specific or hardware-derived value measurement or feature that is specific to the component. An important requirement of these information sources is that the information be repeatable and identifiably different on another system. In other words, finding that a system Video card is ‘VGA-compatible’ is not, standing alone, a sufficiently distinguishing source of information because virtually all PCs would share that identifier. However, if it always takes 12 microseconds to access Video Port VAE at port 46E8h, this would be specific component information source suitable for use in producing the identifier, as it establishes two identities (i.e., that a video circuit is in the system, and that there is a minimum level of performance for that video circuit). If the video card were ‘upgraded’ the access time would likely be the same or faster.

As data files are normally stored on a local hard drive, the hard drive is a natural candidate for sources of information for production of forensic identifiers. In many cases, the hard drive will be a sufficiently specific information source, and the remainder of the system identifiers are not of any consequence.

The strongest single component identifier information source is the hard drive identifier found in the ATA Device Information, which comprises a 256-word (512 byte) description of the drive, including a unique 160-bit internal drive serial number. The ATA Device Information is obtained by sending drive controller port 1F7h command ECh and reading the returned data from port 1F0h. This identifier is strong enough to use as a forensic identifier for a given drive. It can be implemented on a literal bit-by-bit basis or the returned value or a portion thereof (First 128 bytes) can be used to generate the forensic identifier. The forensic identifier produced is a drive-specific identifier, and does not change over the life of the drive. It is also immune to system crashes, repartitioning or reformatting the hard drive, and is constant across all operating systems.

Other hard drive-related values can be used if the ATA Device Information is indistinct (all the same value) or unavailable (not supported).

The hard drive partition table (Track 0, Sector 1) offers a wealth of information about the installed hard drive, and can be used to validate where the Software is authorized to operate.

A comparison of the Hard Drive true accessible capacity against what the System thinks it is can identify an illegal drive swap to a different system. Older system boards do not support newer large drives and many cannot physically access all the cylinders on the drive—a good indication that the drive has moved from its original system.

The type of hard drive interface is also a good source of information. This can tell if an attempt has been made to ‘clone’ the original software onto a drive with a different interface type. The interface can be coded into one or two bits (IE one SCSI bit, or a two-bit ID for ESDI, IDE, EIDE, and SCSI).

Another source of information is the disk parameter table, located at Real Mode address 0:104h for drive 0, and at Real Mode address 0:118h for drive 1. This table identifies some very specific parameters about the Drive, both for ‘Standard’ drives and the new large drives that use EBIOS. Interrupt 13h function 48h will also return this information.

Few hard drives are manufactured perfectly and drives contain a manufacturers ‘Defect Map’, which maps good sectors into the address of bad sectors. The defects are not visible to the end user, and are typically located in the last drive track plus one. The information associated with the defect map is an excellent source of information because this defect table is created during the manufacture of the drive and tends to be unique to each drive.

The hard drive serial number in the drive boot sector is a randomly derived value, which can be copied and is not permanent. A True Drive Serial Number would be a CRC-32 of the ATA Device Information (see above), with a compromise risk of 0.000000047 percent. This is sufficient for many applications of the invention.

A diskette drive can be a source of information usable in creation of a forensic identifier. For example, a user is unlikely to downgrade from a 2.88-Megabyte diskette drive to a 1.44-Megabyte drive.

Another component information source is procured by measuring various system speed sources. This “system speed index” (which is closely related to actual CPU-speed) can be used to identify a specific combination of system board, CPU and Clock. This value is quite personal to the system and can measurably vary between “identical” systems due to slight variations in component tolerances, chips and crystals. Pursuant to one embodiment of the invention, the speed value, Timer 2 is used (Mode 3) in a tightly controlled loop to arrive at the System speed index. This index will be consistent for any specific System Board and CPU combination, with some tolerance given for thermal effects. Timer 2 is used as it is available on all (IBM PC-compatible) systems and is not critical to any operating system or Hardware on the system. On other systems, differing from the IBM-PC hardware standard, a speed index may be generated in an equivalent manner appropriate for the system.

Another component information source is the Dram ‘Refresh’ clocking value (Timer 1). This information is specific to a given System board and BIOS combination. This is a very quick and simple information source, and the value obtained is dependent on the System ‘Refresh’ wiring. While not unique enough in itself to separate all systems, this can catch the ‘Move all Hardware to another system’ pirates.

Another information source is the microprocessor serial number, which can be obtained by polling the microprocessor. Microprocessors from several manufacturers (e.g., Intel, Cyrix, AMD, Motorola) are manufactured and have either unique “serialization” numbers or other measurable CPU identifying characteristics.

Another information source is the memory ‘access’ times between different memory chips. Different chips have slightly different characteristics.

The CMOS memory addresses above 16_{base 10} have a wealth of values that are unique to a given system and its associated hardware. Addresses below 16_{bse 10} have basic system configuration information, generic to most systems. For example, CMOS address 2E and 2F_{base 16} contain a configuration checksum for the CMOS system hardware configuration which is often different, even on identical systems with identical date codes on the System Boards, CPU, and BIOS. Additionally, there are many Vendor-specific addresses in the CMOS, including (base 16) addresses 1B through 2D, 34 through 36, and 38 and upwards.

ROM areas contain specific information about the cards installed in any given system, with the ROM table for the system available through interrupt 15h, function C0h. Likewise, model-specific bytes are available in the final word of BIOS ROM, although model-specific bytes are too generic to use as an effective component information identifier source.

EISA systems have text string ‘EISA’ at real-mode address F000: FFD9_{base 16} and both EISA and PCI system boards can be verified through interrupt 1Ah.

A Wealth of EISA information about the specific cards in a system is available through Interrupt 15h, with an additional 8 kilobytes of system EISA configuration at extended EISA ports 800h through 8FFh.

Network Interface Cards (NIC) contain unique addresses, but are frequent candidates for failure or upgrade. These are also too easily moved between systems to qualify as permanent elements of a particular computer apparatus, unless the network card is the actual lock, in which case the NIC would become a physically transferable ‘key’ to the data or program. This implementation is especially useful on ‘diskless’ work stations, which do not have any fixed disk drive but connects to a common host, typically a network, to host its operating system, data or applications for its operation.

As noted earlier, the forensic identifier is produced by obtaining information from one or more components within the device, and then performing a mathematical operation on said information to produce a binary key that is unique to that information. The preferred mathematical operation is a 32-bit cyclic redundancy check (32-bit CRC). The performance of a CRC-32 on numeric or alphanumeric information obtained by polling or querying one or more components will produce a binary key having a fixed length independent to the size of the string of data upon which the operation is performed. Thus, the data source for the CRC may be segmented to produce multiple CRCs, thereby creating a longer length of the binary key that results.

The information that can be used to produce the forensic identifier can include combination of singularly unique, partially unique or arbitrary data strings. Thus, information can be extracted from measurement or polling of a number of components in the computer, assembled through combination, concatenation or other procedures, and then subjected to the CRC-32 operation. Information can also be included according to pre-defined rules.

Consider the example of software that is produced by a software vendor. In this example, a set of arbitrarily assigned product and producer codes consisting of alphanumeric or numeric strings can be used in combination with machine-specific information to produce a forensic identifier that “marries” the particular data product to a particular computer. In this example, a nomenclature is used whereby a producer code is assigned and controlled by a single entity to avoid duplicative assignments of codes to distinct vendors. The vendor can then assign product codes that are unique to each specific information product produced by that entity (e.g., the data to be secured). The two sources of information when combined will uniquely identify the specific data product. For example, a 16 digit producer identifier (e.g., ABCD-0002-2323-0001) could be combined with (e.g., concatenated) a 16 digit product identifier (e.g., 2001-0001-0001-0004) to yield a 32 digit string (i.e., ABCD-0002-2323 -0001-2001-0001-0001-0004). This information would then be combined with information from one or more components in the computer upon which the data product is to be used. After being combined through an appropriate operation, one or more CRC-32 operations are applied to the data to produce a binary key. The binary key will be unique to the combination of vendor identity, product identity and machine providing the information.

Depending on the degree of “uniqueness” desired (i.e., to identify a single specific computer having a specific set of unique components, up to a general identification of a class of computer having a single or few common characteristics), more or less component information sources will be used to produce the forensic identifier.

A ‘Simple’ (128-bit) System Hardware Identity can be generated by bit-concatenation of the following components: BIOS Manufacturer Name checksum (16-bits) & Speed Index (16-bits) & Dram Refresh Count (16-bits) & Sector of Drive 0 Partition 1 Directory (16-bits) & True-Capacity Sector count (32-bits) & True Drive Serial Number (32-bits) combine into a singular 128-bit Number that very significantly identifies an individual System.

A ‘Compound’ (128-bit) System Hardware Identity can be generated by bit-concatenation of the following components: Compound BIOS Checksum ={0 (4-bits) & EBIOS present (1-bit) & PCI System (1-bit) & VAE On Board (1-bit) & VAE On Card (1-bit) & VAE Port access time (4-bits) & ROM Areas In Use (4-bits)} XOR BIOS Checksum,

A Complex Compounded (128 bit) System Hardware Identity can be generated by bit concatenation of the following components: Compound BIOS Checksum (Compound 16-bits) & Speed Index (16-bits) & Dram Refresh Count (16-bits) & Sector of Drive 0 Partition 1 Directory (16-bits) & True-Capacity Sector count (32-bits) & True Drive Serial Number (32-bits) combine into a singular 128-bit Number that very significantly identifies an individual System.

An ‘Extended-Security’ System Hardware Identity can be generated by bit-concatenation of the following components: EBIOS present (1-bit) & PCI System (1-bit) & VAE On Board (1-bit) & VAE On Card (1-bit) & VAE Port access time (4-bits) & CMOS Configuration Checksum (8-bits) & Speed Index (16-bits) & Dram Refresh Count (16-bits) & Hard Drive Defect map CRC (16-bits) & True-Capacity Sector count (32-bits) & True Drive Serial Number (32-bits) combined into a singular 128-bit Number that is extremely individual to a specific System.

In each of these scenarios, the processes include one or more data collection steps whereby the information associated with the component(s) are collected. Such processes involve collection of the data by querying of the variously specified components, the selection of which will be dictated by the initial security process and user preferences. For example, when the security strength is determined during the first stage of the process (i.e., where the binary key is first created using the device information), the components that are to be used to provide information for creation of such a key will be identified in a suitable manner. When the key is sought to be recreated at the time of authentication, the same component information sources will be polled or evaluated again and used to “recreate” the key.

General purpose computers are not the only devices that are suitable for use in production of forensic identifiers. Essentially any device that has components that are integral to the device and have operational or static characteristics may be used pursuant to the invention. If the characteristics of the components can be measured or identified, a forensic identifier of varying specificity may be the created for the device. Accordingly, consumer electronics products including but not limited to DVD players, CD-players, cassette players, MP3 players, printers, scanners, zip drives, may be assigned forensic identifiers.

The level of uniqueness of information is variable and is dependent upon the level of security desired. The level of desired uniqueness is selected to correspond to either a particular device or to a class of devices. For example, if the rendering device is a computer and the security level desired is to that of a single device then the probing process will collect such information that is necessary to uniquely identify the specific computer in question. This may include, for example, three, four, five or more individual component information sources that in combination are as a statistical matter unlikely to be replicated in any other computer or device. is more detailed in nature than security on a class of devices (i.e., a more generally defined category of computers sharing common characteristics, performance profiles, etc.). The probing process generates information that is unique to this device only.

As noted above, production of forensic identifiers for specific devices is the first step for the security processes of the present invention. The second step can be generally described to be association of the identifier with the digital information being secured. The association may be conceptual (e.g., part of the design of the protection system) or an explicit element of the process (e.g., a step that must be performed). For example, a software program that is to be secured through the invention would incorporate procedures that perform the authentication process using information produced during the installation of the program onto a specific computer. The data comprising the binary key against which the authentication is to be tested is stored on the computer system or on a server accessible to the system. The software subroutine collects the data comprising the key from the pre-assigned location and uses it during the authentication process. The data comprising the binary key may be stored in a discrete file or embedded in executable or data files used by the program. The data comprising the binary key can also be stored in multiple locations for redundancy purposes or to provide greater degrees of security. The data comprising the binary key can also be embedded or associated with data that is to be rendered in other devices (e.g., data representing an audio or audiovisual work, or an image or text file). The location of the data comprising the binary keys can be placed in the information to ensure that any illegal copy contains the identifier. For an audio file, the identifier may be inserted as a point in the file at which the authentication process searches for comparison purposes in response to a request for access to the information. However, one having skill in the art will realize that any number of locations are possible for associating the identifier with the information.

The third step of the invention in general terms is to secure the information by steps that will prevent the rendering or use of information to be secured in the absence of an acceptable authentication result. Again, any number of techniques may be employed to accomplish this result. In general, however, the authentication test will be performed in response to a request to access, use or render the information by the device. Following that action, an authentication routine is initiated whereby the rendering device is probed to obtain the component information that is needed to perform the authentication test. Such information will be incorporated into the logic implementing mechanism (e.g., software code, programmed circuit) such that the proper components are polled and information obtained from the same are evaluated. The information obtained by such process is then used to generate a binary key using the suitable algorithm (e.g., the 32-bit cyclic redundancy check). Once generated in this process, the stored key is compared to the generated key to measure authentication. If the authentication measurement meets the pre-defined criteria for approval, a positive authentication result is provided. Such positive authentication result then permits the continued operation of the procedures that are generally employed to access, use or render the data being secured.

Any algorithm suitable for use in authentication procedures based on binary keys may be employed to perform the authentication. Examples of suitable authentication algorithms include simple bit-by-bit comparisons of measured or derived values, algorithmic mathematical operations which produce a unique result for all combinations of input values, true/false algorithms which output a predefined fixed state (i.e. TRUE or FALSE) based upon the algorithm arriving at an expected state, condition or value while processing the input data. For example, a 32 or more bit Vendor Identification number raised to the power of the 32 or more bit Vendor-assigned product number raised to the power of the 64 or more bit system-specific combined forensic identifier results in a significantly large value which is unique to each permutation of Vendor, Product and system forensic identifiers. In practice, the entire result is not required for most applications, and the result can be scaled to the level of confidence required, i.e. 128 bits or more. Both simpler and more complex algorithms can be used to achieve the validation, based upon the level of identification and security desired.

If the authentication result does not meet the pre-defined standard for a “positive” authentication, the procedures of the current invention will prevent access, use or rendering of said information, as appropriate. The prevention of access, use or rendering is accomplished by a variety of mechanisms. One example is by termination of the executable process of a computer program. This can be implemented both in respect of a program that installs a computer program onto a particular computer, or by preventing operation of the computer program once it has been installed on the computer.

Another mechanism is through the disabling of the rendering device. For example, if the digital information is in an MP3 player, the device could be disabled from playing the information. Specific preventative steps could include a simple hardware-disabling measure such as a blown fuse or a measure of higher complexity, such as altering the rendered data, and directing that the output be incoherent. Another example of the disabling of the rendering device is the generation and displaying of an error code that prompts the user to provide an additional authorizing number in the event a negative authentication is detected. Absent insertion of a new code in response to that query, the device or program will cease operations. This error code could inform the receiver of the call (for example, a distributors ‘Support’ phone center) that an illegal copy of the digital information has been obtained. The level of protection desired in securing the digital information is in no way limited to the examples cited. One having ordinary skill in the art would comprehend that the an almost unlimited number of permutations exist to disable the rendering device. The only limitation that truly exists is the degree of disabling that the owner of the digital information desires.

Another securing technique pursuant to the invention is to encode the digital information during installation using an algorithm in conjunction with the binary key that is created as the forensic identifier. Each time the authentication routine returns a positive value, the digital information is then decoded and made available to the rendering device for use. Alternatively, the information can be stored in the encoded format, and unless a positive authentication result is maintained during the rendering process, the information will not be able to be decoded. Thus, processes are included during the rendering process that incorporate a decoding step incidental to the rendering process for the data which is stored in the encoded format. The decoding process will employ the binary key that has been recreated using information from the rendering device.

The invention as described is applicable to a number of specific security procedures. The examples provided below illustrate the application of the invention in a number of distinct examples, however, the invention is more broadly applicable to any process that employs an authentication procedure dependent on use of a binary key.

Example: Secure Transfers of Information

This example is well-suited to transfers of data over a network, including the Internet. In a first step, the information needed to generate a forensic identifier is collected from the device that will ultimately use or render the information. The information is used by the device to generate a binary key which is then transferred to the site on the network where the data to be transferred or which controls such transfers. Alternatively, the information is transferred and a computer receiving such information over the network uses it to generate the binary key. In either example, the binary key may be produced using a 32-bit cyclic redundancy check operation or may use the raw or otherwise processed binary key. The examples of devices including general purpose computers as illustrated above serve as choices for component information sources.

Once the information or key has been transferred to the computer that will initiate the transfer of information to be secured, said computer encodes the data to be transferred using an algorithm in conjunction with the key produced using said information. If the key has not been generated prior to this step, the computer generates the key. The information once encoded is transferred through the network to the device that is to render the information. Once received, a process is initiated which collects the information needed to generate the binary key by polling the previously selected components for the component information, and said key may be produced by performing a 32-bit cyclic redundancy check on said information or may use the raw or otherwise processed binary key, identically to the host which externally generated the key, to arrive at the same key Following this step, a process is initiated whereby the encoded information is decoded using the algorithm in conjunction with the thus created key. If the key does not work in conjunction with said decoding algorithm, the information will remain encoded and inaccessible to the device.

In a slight variation of this process, the key that is used to encode the data is transferred, either within or separate from the file comprising the encoded data. An authentication procedure is then employed whereby the key as transferred is compared to the key as generated after the file has been received by the device. If the authentication test does not satisfy a pre-defined standard for approval, the decoding algorithm cannot be initiated. Alternatively, if the authentication test is not valid, a time or frequency limited usage counter may be employed to authorize a limited number of uses of the data. In the circumstance of the data being an executable file usable in a general purpose computer, the time or frequency limitation may be incorporated pursuant to an installation procedure that stores executable files needed for operation of the program onto the computer.

A specific encoding mechanism for secure transfers is also employed. The mechanism relies on a particular organizational schema for transferring data. The actual content of the data to be transferred is unimportant. Audio, Video, Document, Database, Spreadsheet, or E-mail—they are all the same from the perspective of the invention. The only true requirement is that the data remain static (unchanging) for the short time (typically measured in microseconds) required for it to be encoded with the forensic identifier.

The organizational schema of the mechanism provides that the data item is divided into finite sets, or ‘Blocks’ of digital information. These blocks can be any convenient length, with 32K considered the ‘Standard’ block size. Each block is encoded individually into a secure packet which is structured as follows:

[Signature][Data Size_{unencoded}][Data Content_{encoded}][Data CRC-32_{encoded}][CRC-32_{unencoded}]

[Signature] identifies the Security level of forensic identifier (16-bit, 32-bit, 64-bit, 128-bit, 256-bit, etc. up to 65536-bit).

[Data Size_{unencoded}] identifies the size of the remaining Packet, including both [CRC-32] values. [CRC-32_{unencoded}] validates the integrity of the entire Packet before any attempt at decoding the encoded information. The [Data Content_{encoded}] and the [CRC-32_{encoded}] are decoded based on the forensic identifier produced using the receiving device. After [Data Content_{encoded}] and [CRC-32_{encoded}] are decoded, CRC-32 is verified against Data Content CRC-32. If the decoded [CRC-32_{encoded}] matches the Data Content CRC-32, the data is valid and available.

The encoded data cannot be decoded without the ‘correct’ forensic identifier which cannot be determined from evaluation of the encoded data before it is decoded. This eliminates any hope of [CRC-32_{encoded}] being used as an aid in attempting to decode the data as the [CRC-32_{encoded}] will be incorrect for any possible decoded forensic identifier value except the correct one.

As the encoding is based on the device-specific forensic identifier value(s), which must be created from the device, there is no effective means of attacking the data except a “brute-force-trial-and-error” approach, which would take countless iterations and hundreds of years. Instead, access is possible only through possession of both the physical device and the data.

TABLE 2
Forensic Identifier Security Format Details:

[Signature][Data Size_{unencoded}] [Data Content_{encoded}] [Data CRC-32_{encoded}] [CRC-32_{unencoded}]
The Signature identifies a validly encoded packet “FX”. The next byte is a base 16 ‘Power’
value that indicates the raised power of 2 that is required to decode the packet.
[Signature] = “FX4” = Security Data Level 4 = 2⁴ = 16-bit forensic identifier
[Signature] = “FX5” = Security Data Level 5 = 2⁵ = 32-bit forensic identifier
[Signature] = “FX6” = Security Data Level 6 = 2⁶ = 64-bit forensic identifier
[Signature] = “FX7” = Security Data Level 7 = 2⁷ = 128-bit forensic identifier
[Signature] = “FX8” = Security Data Level 8 = 2⁸ = 256-bit forensic identifier
[Signature] = “FX9” = Security Data Level 9 = 2⁹ = 512-bit forensic identifier
[Signature] = “FXa” = Security Data Level 10 = 2¹⁰ = 1024-bit forensic identifier
[Signature] = “FXf” = Security Data Level 16 = 2¹⁶ = 65536-bit forensic identifier

The Data Size is a 16-bit count of the number of Bytes in the Data Content portion of the Packet. It also includes the size of the two CRC values that follow the data, but not the Signature bytes, or the Data Size.

[Signature][Data Size_{unencoded}][Data Content_{encoded}][Data CRC-32_{encoded}][CRC-32_{unencoded}]

The data Content is exactly the data that was input to the original packet before it became a ‘Packet’. When the packet is correctly decoded, it is also exactly what is returned from the packet.

[Signature][Data Size_{unencoded}][Data Content_{encoded}][Data CRC-32_{encoded}][CRC-32_{unencoded}]

The Data CRC-32 field is the actual CRC-32 of the Data Content and is encoded and decoded along with the Data Content. While the Packet is in an encoded secure format, the CRC-32 is also encoded, and cannot be used as an aid to crack the packet data. After the Data Content is decoded, the decoded Data Content CRC-32 will match the decoded Data CRC-32, which validates the forensic identifier as well as indicating that the data content was successfully decoded.

[Signature][Data Size_{unencoded}][Data Content_{encoded}][Data CRC-32_{encoded}][CRC-32_{unencoded}]

The final CRC-32 is never encoded. It is the overall Packet CRC used as an error checking and integrity value ensuring that the entire packet was received exactly as sent.

Example: Preventing Use of Data Files by Devices Other than as Authorized

In this example, a forensic identifier is used to prevent the use of files that have been stored on a device by other devices. The example is particularly well suited to computer programs that have been installed on a specific computer.

In one example, the forensic identifier is generated during the course of the installation process for a computer program. The installation program polls pre-selected components in the computer system to obtain the component information associated with such components. This can be done by relevant function calls, often termed “gestalt” inquiries, or by any other suitable procedures. Optionally, product and vendor code information can be added to the information collected. The options specified above in relation to the degree of security desired can be applied in this example. Once the data is collected from such polling and the optional inclusion of the vendor and product code information, the installation program generates the forensic identifier by applying a cyclic-redundancy check on such information or may use the raw or otherwise processed binary key to generate the forensic identifier.

The forensic identifier can then be associated with the installed program in any appropriate manner. One way is to simply store the binary key in a discrete file in the computer's hard drive. The binary key can also be embedded or otherwise inserted into one or more executable or data files associated with the computer program. If the computer is operating over a network or relies on server-based computers, the binary key can be stored on a different computer. In all of thee examples, the location or manner of storage of the binary key has no bearing on the security of the system.

The next step of the process occurs when a user or other entity wishes to initiate execution of the installed computer program. At this stage (i.e., initiation of the executable files), a routine is called that generates the forensic identifier using the same criteria as used to produce the original binary key. This is performed incidental to or prior to the initiation of the computer program. After generating the binary key, the generated key is locally authenticated against the hardware, vendor and product combined identity. If the authentication test returns a positive result (as defined by the entity controlling the security system), the authentication routine concludes and the executable program is permitted to commence.

Example: Media Limited File Access

In this example, the forensic identifier is produced using information associated with a specific physical medium upon which data files are stored. Such media may include floppy disks or optical media such as CD-ROMs or DVDs to large storage devices, including tape and ZIP drives and removable hard drives. This example is well suited to data files that are distributed on physical media, including computer programs, or music or video files.

The first step in this process involves production of a forensic identifier using a measurable physical characteristic of the medium containing the files comprising the data to be secured. The measurable characteristics may be operational or static characteristics of a device (e.g., a removable hard drive or zip disk, which has multiple components that can be measured when in operation). Alternatively, for optical or magnetic media, the characteristic can be imparted through a physical modification of the medium. The physical modification may be an encoding onto the magnetic or physical structure of the medium of a specific binary key. Alternatively, a binary key can be generated, embedded in a circuit and physically attached to the medium. Where the medium is an magnetic disc (e.g., diskette) which is inherently write-enabled, a method of installing an original media forensic identifier that can not be copied must be implemented in a way that allows the diskette to be written and read on existing hardware, while maintaining the copy-proof original media identity.

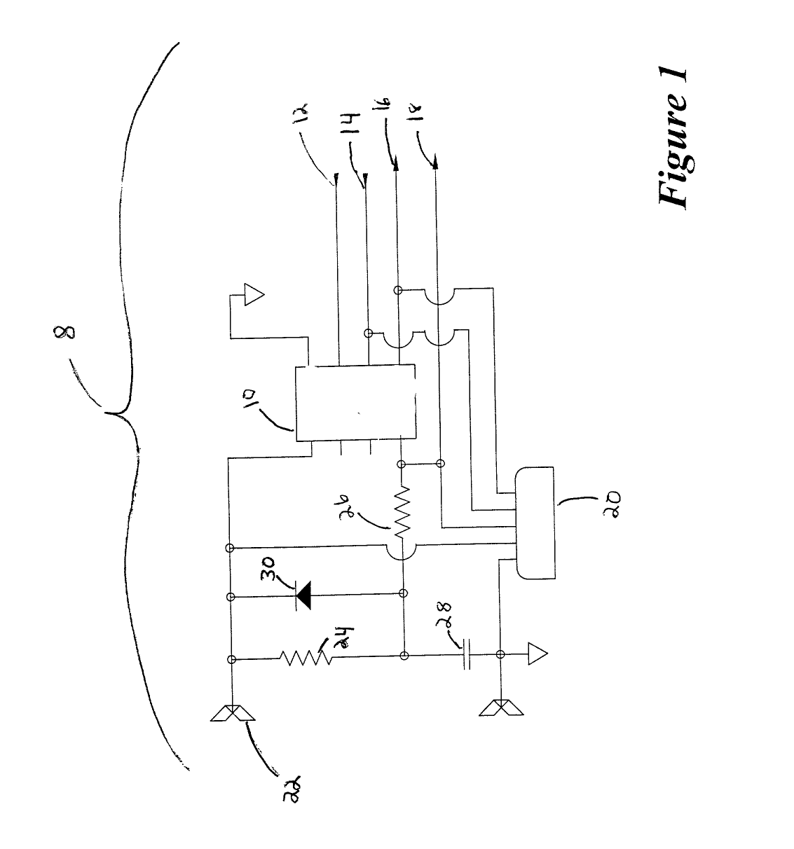

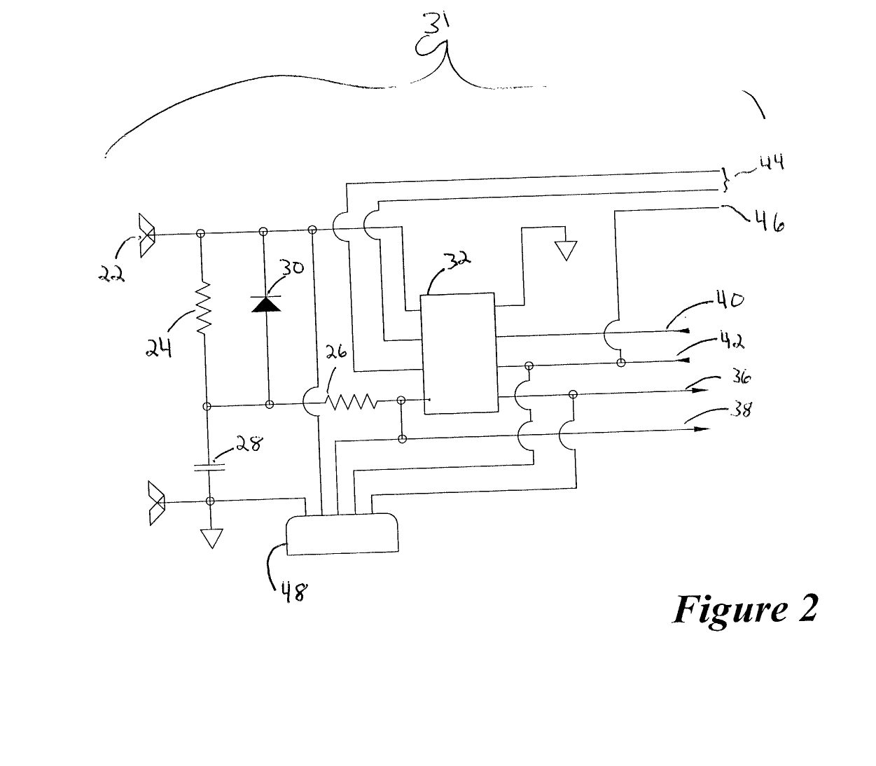

FIG. 1 is a schematic of a lock system according to the present invention. The schematic implements a device (8) that is fixably attached to an object in order to secure the object. At the core of the invention is a programmable integrated computer chip (10) capable of transmitting (12, 14) and receiving (16, 18) bits of data. The programmable integrated chip (10) is linked to a programming connector (20) which permits programming of the integrated chip with desired information, i.e. a unique identifier, to secure the object. The schematic also is equipped with common elements to that of FIG. 2. These elements are the power supply (22), resistors (24, 26), capacitor (28) along with diode (30) which all ensure a smooth and efficient operation of the device but in no way are unique to this device and are interchangeable with a number of combinations as one of ordinary skill recognizes.

FIG. 2 is a schematic of a communication system (31) for operation with the lock system of FIG. 1. The schematic implements a device that is not fixably attached to the object being secured. The device is remotely affixed apart from the device shown in the schematic in FIG. 1. As in FIG. 1, the core of the schematic is a programmable integrated chip (32) that is capable of transmitting (36, 38) and receiving (40, 42) data. However, the chip (32) is also capable of transmitting control bits of data (44, 46) in response to the data received from the device (8) in FIG. 1. The control bits (44, 46) are directed to the device (8) to initiate a preprogrammed action. As with the device (8), a programming connector (48) permits the device (8) to be programmed with information, i.e. control codes, unique identifier equivalent to that programmed into the device (8) of FIG. 1.

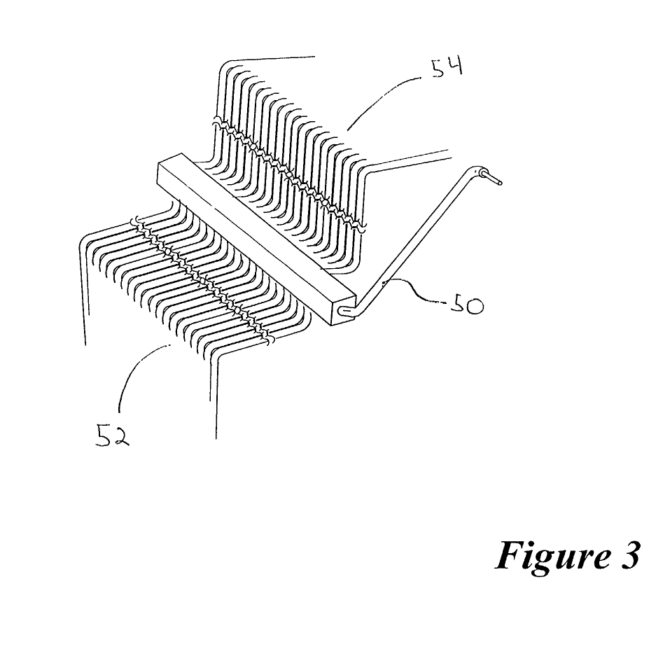

FIG. 3 describes a generic class of devices for inputting an in-line data decoding circuit (50). One implementation of this device as shown in the figure is in a computer where the decoding device is attached to the disk controller (52) and diskette controller (54) between the controller and the storage device. All data that is sent through the controllers (52, 54) is garbled. Any attempts of removing data from the computer are impaired by the implementation of this device in this specific location. For instance, a user who attempts to copy the data to a computer-readable medium will have the data garbled prior to the data being stored on medium. Any data stored on the disk is only capable of being retrieved by this specific computer which decodes the data after an inquiry to retrieve the data on the disk. In the specific area located near the vicinity of the computer is where the device (31) in FIG. 2 is placed. The device (31) is placed away from the computer and is not attached to it. The device (31) in FIG. 2 along with the decoding circuit (50) ensures that the data on the disk can be retrieved from the computer from which it is authorized to be accessed.

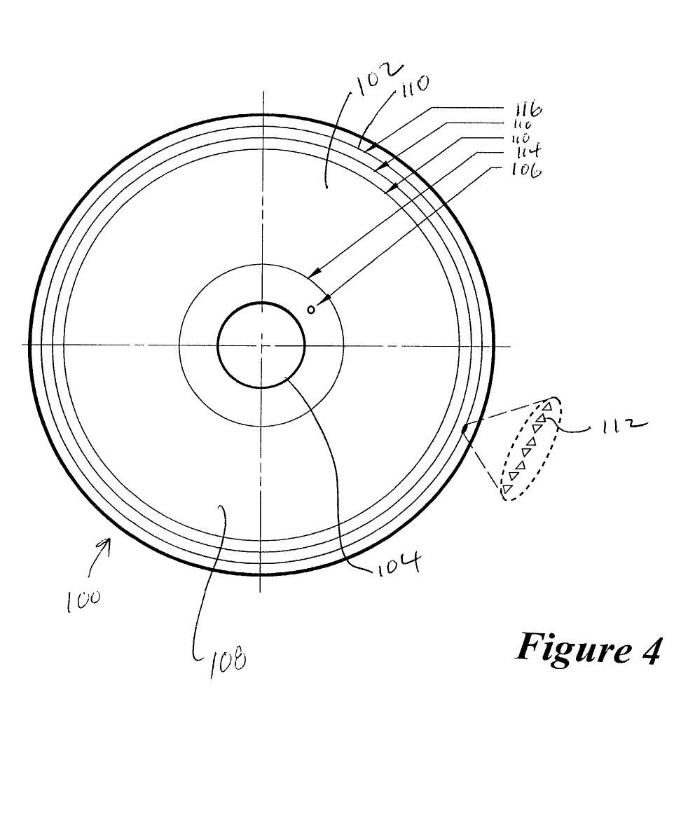

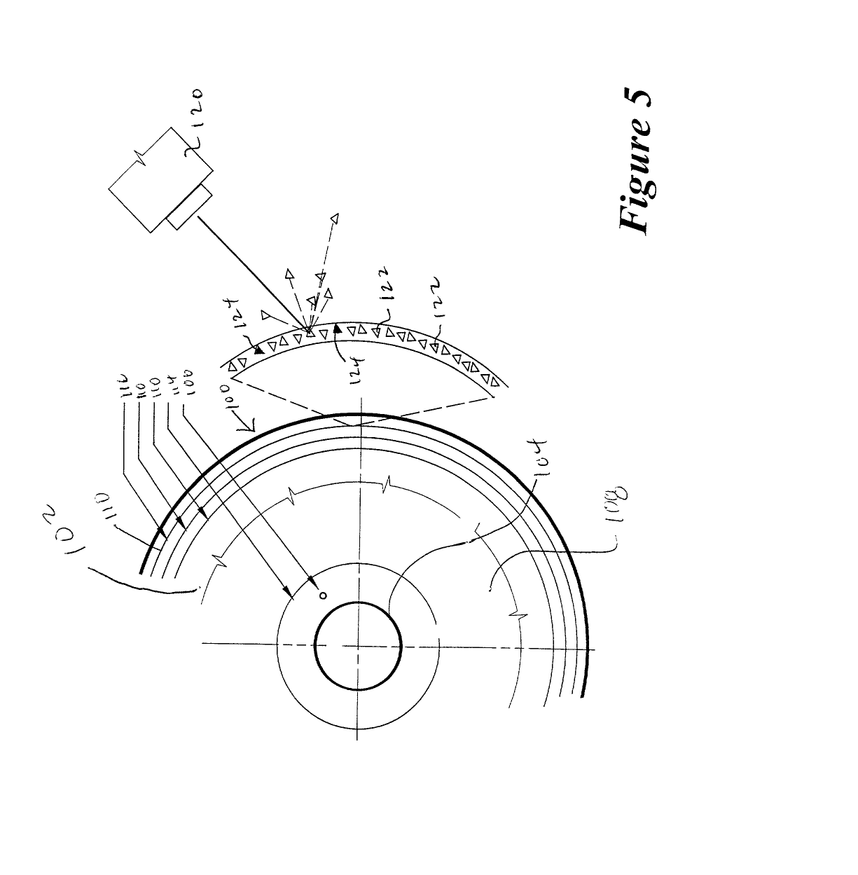

FIGS. 4 and 5 relate to the above-described system for securing digital information that has been stored onto an optically readable medium. While it is envisioned that any media may be appropriate for this system, a CD-ROM diskette is used for demonstrative purposes. However, it is to be understood that this embodiment of the present invention may find application for any optically readable medium.

FIG. 4 illustrates a diskette, generally illustrated as 100, of the type commonly used as a computer-readable medium. The diskette 100 includes a disk portion 102 and a hub portion 104. An index hole 106 is formed in the disk portion 102. The disk portion 102 includes a surface 108 which is covered with an easily magnetized (that is, permeable) oxide as is known in the art. A plurality of concentric rings or tracks 110 are formed on the surface 108 by magnetically aligning bits of oxide 112 (as shown in the enlarged view) into a series of charges that can be rewritten or read back from the oxide surface. The innermost track, a track 114, is referred to as track “N” while the outermost track, a track 116, is referred to as track “0”, with the remaining tracks being numbered 1, 2 . . . from the outermost track 116 “0” toward the innermost track 114.

Each of the tracks 110 is subdivided into smaller areas called sectors. A sector is the smallest readable or writable unit on a diskette and typically holds 512 Bytes of user data.

FIG. 5 discloses a first embodiment of security according to the present invention that may be provided for protecting magnetically readable media. This embodiment generally relates to the treatment of magnetic media by a laser. Specifically, on magnetic media such as, without limitation, diskettes or tape, a surgical laser set on low power, pulsed mode is synchronized to the media through connection with the magnetic head sense amp, is used to destroy the magnetic oxide between the recorded bits. This is illustrated in FIG. 5. Specifically, and according to this embodiment, the diskette 100 of is subjected to a laser treatment by a laser 120. The laser 120 may be of any of a variety of lasers, such as a surgical laser of the YAG type. As illustrated in the enlarged view associated with this figure, the laser 120 is used to vaporize those magnetic oxide particles between the existing magnetic peaks, rendering the oxide too weak to change or store magnetization patterns.

Following the selective use of the laser, no other data can be written correctly to the media over the laser-disabled areas. This procedure “laser-locks” the encoded data into the magnetic media by affecting a change from a normal bit 122 to a “laser-locked” bit 124. A unique identifier can be written and the “laser-lock” can be verified because no other signature will correctly read or write to the same area on the media. The authentication process takes control of the NEC765 (or compatible) PIC within the diskette controller and formats designated sector(s) with an illegal or missing ‘Preamble’ and ‘Postamble’. As the missing sector data can not be read by the controller, without direct manipulation of the PIC registers at specific times at specific locations, the forensic identifier remains intact and can not be copied. Any copy of the original media will not contain the proper forensic identifier or data. This method is employed in such a fashion as to not diminish the original data or capacity of the media.

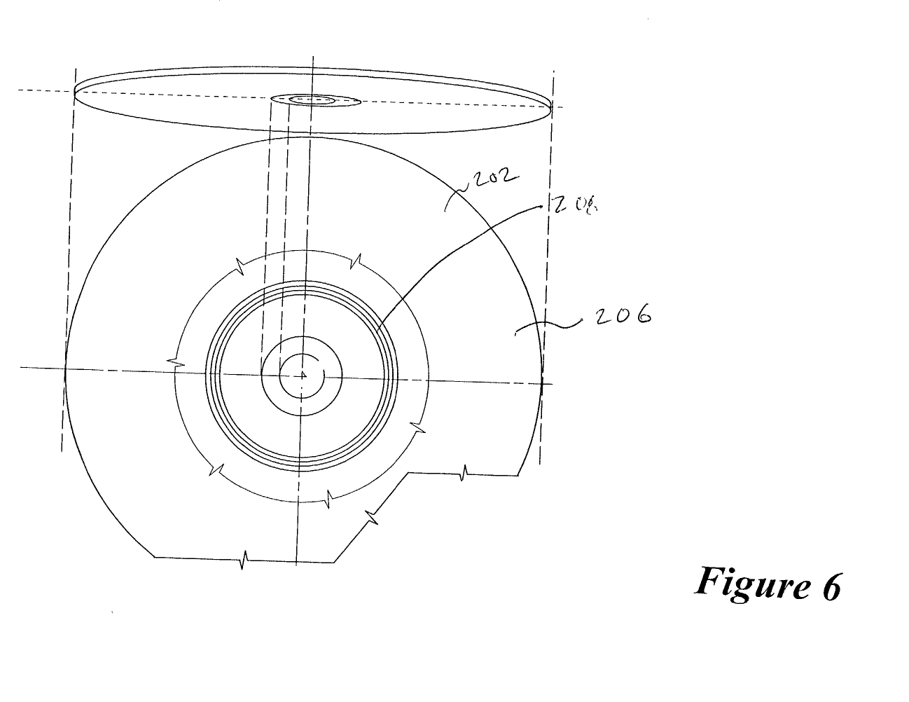

FIGS. 4 and 5 relate to the modification of a conventional optically-readable medium by altering its magnetic composition to establish a security measure. As a further variation of modifications to diskettes, FIGS. 6 through 10 disclose a system according to the present invention in which an optically-readable medium undergoes a more substantial change to provide effective security.

FIG. 6 is a plan view of the major portion of an optically-readable medium, generally illustrated as 200, illustrating the present security in the form of optically-readable data stored thereon. Similar to the disk 100 illustrated in FIGS. 4 and 5 and discussed in relation thereto. The medium 200 which may be a CD-ROM or a DVD, generally includes a disk portion 202 and a hub portion 204. The disk portion 202 includes a reflective surface 206 having one or more spiral of tracks 208 formed thereon in a manner similar to that discussed above with respect to FIGS. 4 and 5.

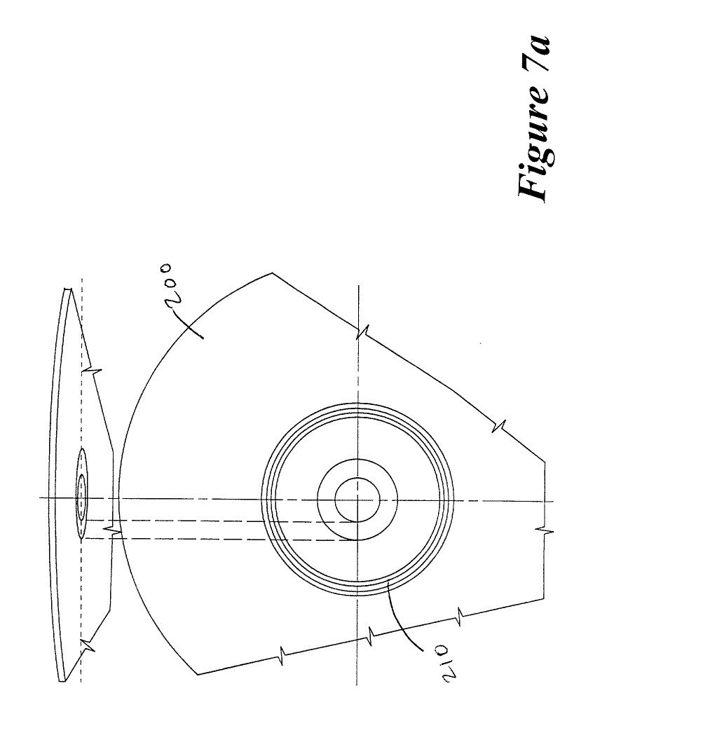

FIGS. 7a through 7c relate to a first substantive modification of the media 200 itself effected at the manufacturing level according to the present invention. According to this embodiment, the surface 206 is modified in a region such as 210 shown in FIG. 7a (although other regions of the disk surface 206 may be so modified) in such a way so as to prohibit photographic copying of the media 200. Specifically, and with reference to FIG. 7b which is a raised elevational view of the media 200, the requisite 3-dimensional data represented by textured surface 212 is ordinarily disposed on the surface 206 (by pressing as is known in the art) of the media 200 in such a way so as to allow reading of the information substantially at a right angle. This method of production allows for the relatively easy copying of the data through photographic duplication methods.

Conversely, and as shown in FIG. 7c, a method of the present invention is to stamp the unique identifying information at an angle represented by textured surface 214 in which the 3-dimensional data can be encoded, whereby the identifying data cannot be reproduced by standard optical replication techniques. Specific decoding hardware (not shown) would be required to allow the data to be read.

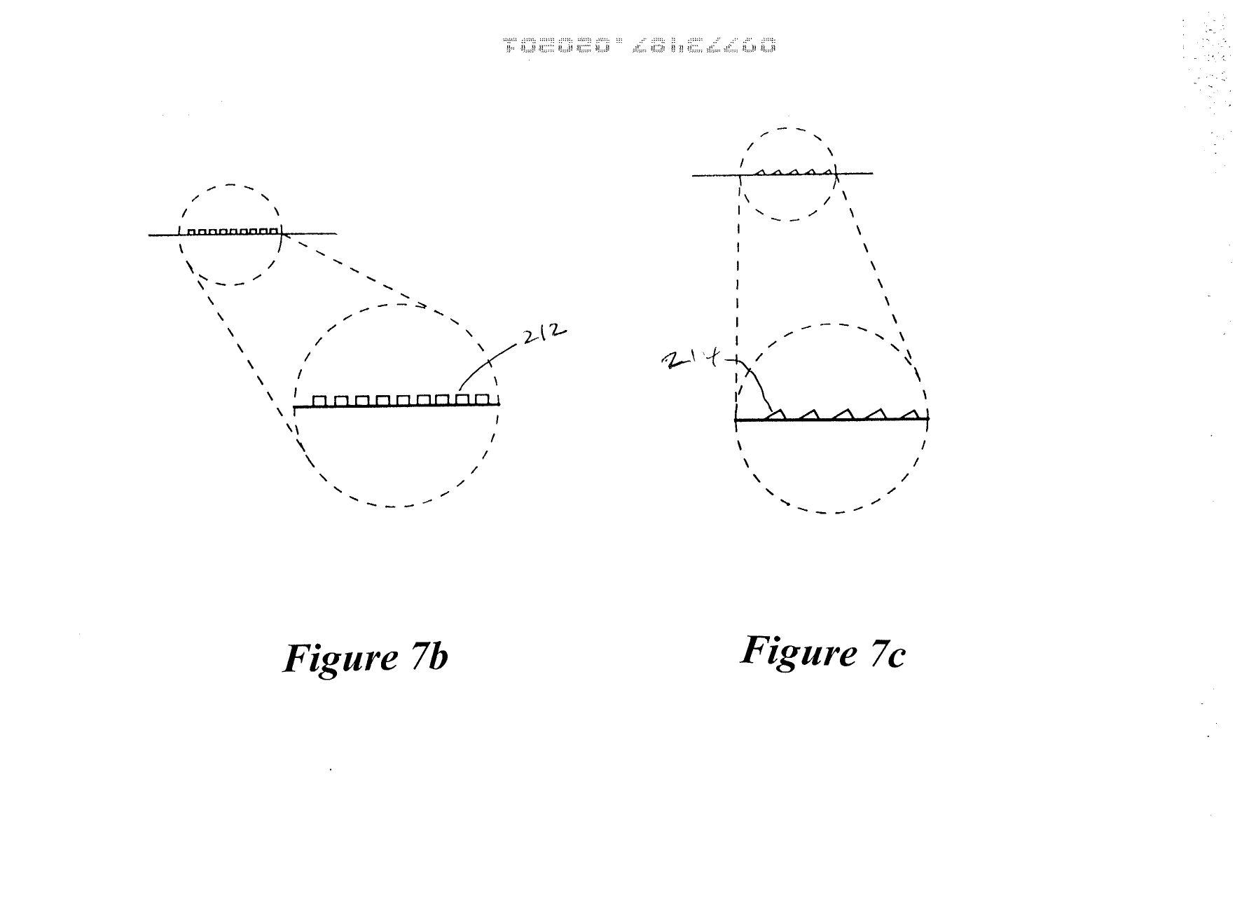

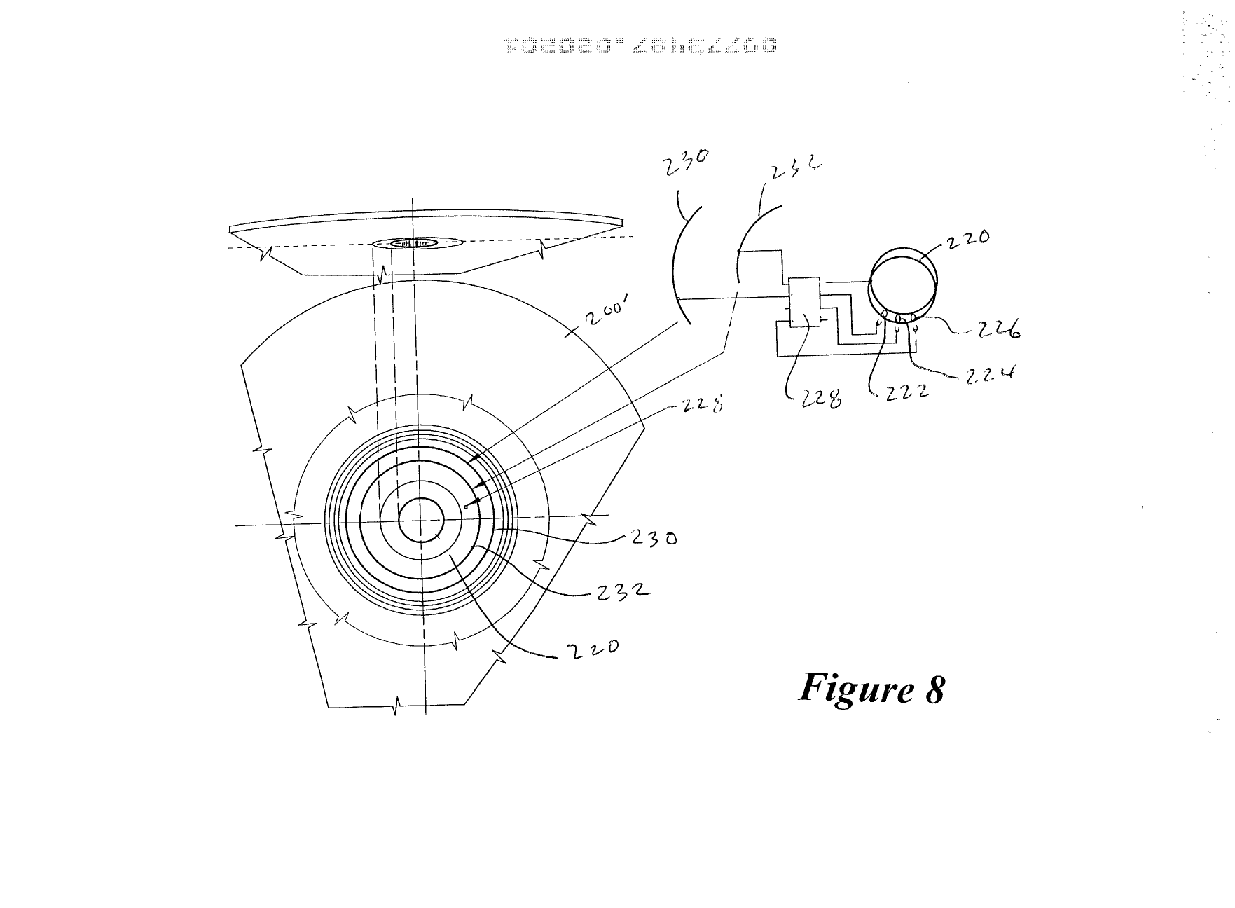

FIG. 8 provides an additional variation of the security system of the present invention as adapted to optically-readable media. Specifically, and with reference to FIG. 8, a modified disk 200′ includes a modified hub 220 which is better illustrated in the enlarged and three-dimensional view shown in association with the disk 200′. A plurality of contacts 222, 224, 226 are operatively associated with the hub 220 for in-hub programming. Each of the contacts 222, 224, 226 is electronically associated with a programmable chip 228. (While the chip 228 is shown in FIG. 9 in the general proximity of the hub 220, it should be understood that the chip 228 may be readily positioned elsewhere on the disk 200′.) The programmable chip 228 is programmed through the hub 220 at any time before the operator obtains the disk 200′. The data on the disk 200′ is installed in an encoded format.

Formed on the disk 200′ is a pair of concentric rings 230 and 232 which are preferably composed of aluminum but which may be composed alternatively of another conductive material. The ring 230 functions as the data out ring while the ring 232 functions as the power+ring. The hub 220 acts as a common (signal) ground for the system.

According to the embodiment of FIG. 8, when the disk 200′ is inserted into a player (not shown), the chip 228 is powered through the hub 220 and the ring 232. The programmable chip 228 waits for a few milliseconds then sends the unique identifier of the disk 200′ to the ring 230 which the player uses to decode the data on the disk 200′ .

FIG. 9 discloses a further variation of the security system of the present invention as adapted to optically-readable media which is related in principle to the embodiment shown in FIG. 8 and discussed in relation thereto. According to the variation of FIG. 9, the disk 200′, the contacts 222, 224, 226, the chip 228 and the rings 230 and 232 of the embodiment of FIG. 8 are relied upon. While some differences in function may arise, the only significant differences worth noting are that the contacts 222, 224, 226 function for in-circuit programming in the embodiment of FIG. 9 as opposed to their function as in-hub programming according to the embodiment of FIG. 8. The data on the disk 200′ is imported in a encoded format.

According to the embodiment of FIG. 9, a modified hub 240 is provided and includes a plurality of programmable chip contact pads 242 operatively associated therewith to be read by a media player (not shown). A hub-locking keyway 244 is formed on the surface of the hub 240. In operation, and relative to FIG. 9, when the disk 200′ is inserted into the player, the chip 228 is powered through the chip contact pads 242 provided on the hub 240. The programmable chip 228 waits a few milliseconds then sends the unique identifier of the disk 200′ through the hub 240 to the player. The player uses the unique identifier to de-garble the data on the media. Importantly, the keyway 244 provides alignment of the hub contact pads with the electrical contacts in the player, thus providing automatic protection of the circuits within the hub assembly. Thus while the media can be readily copied, the disk 200′ of FIG. 9 can only be played with the specific hub to retrieve specific data. In addition, the hub 240 can be re-programmed as required.

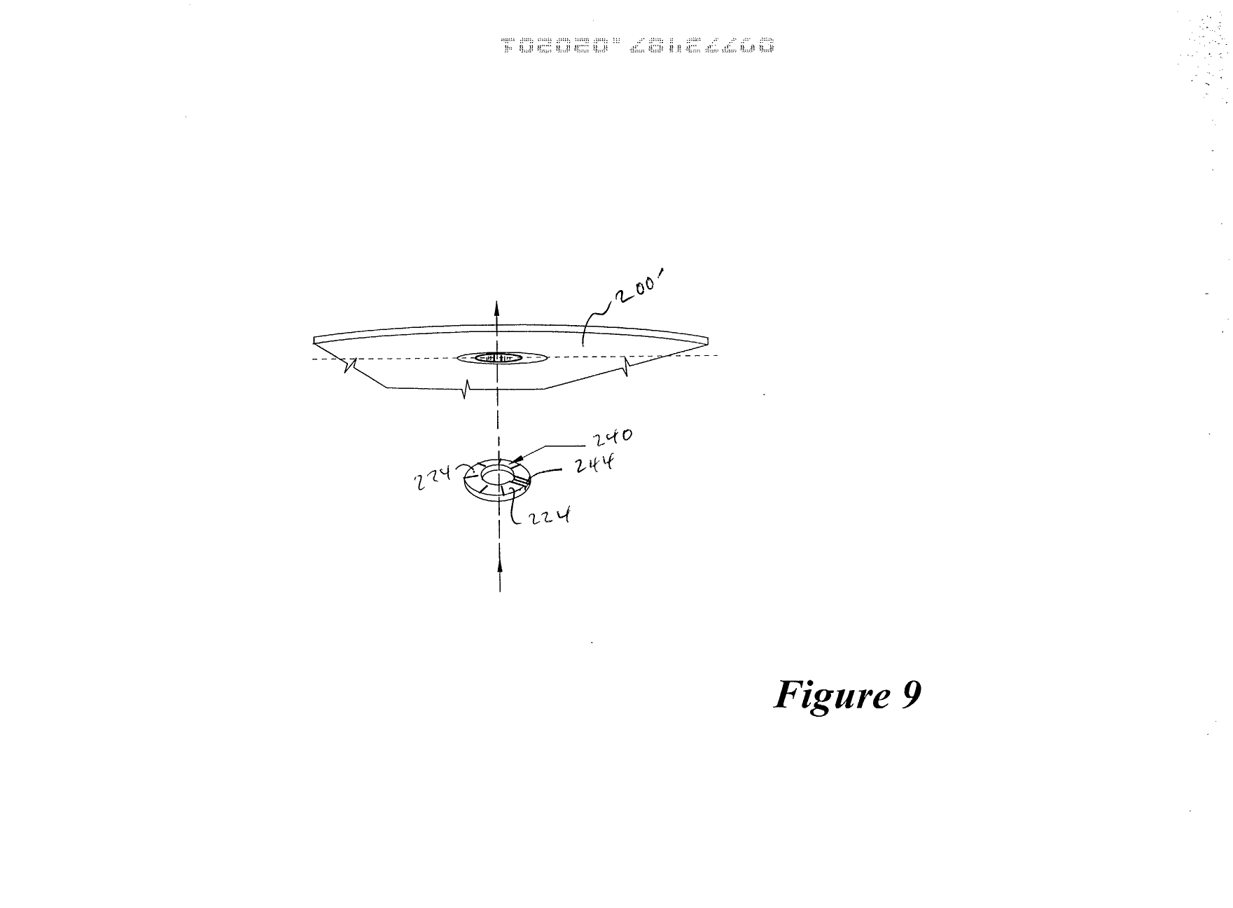

FIG. 10 is the last variation of the examples within family of security systems of the present invention which enable controlled distribution and use of information contained on a disk. Specifically, media such as a disk 200″ includes a hub portion 250 having an interior hub surface 252 and a disk portion 254 having an exterior disk surface 256, the latter being more clearly seen by the enlarged view of the edge of the disk 200″. As illustrated, the hub surface 252 or the exterior disk surface 256 (or both) may be modified to include a digital code. The digital code may be a unique identifier which allows the decoding of data contained on the disk 200″ or may be other media player validating information.

While the digital code may be readable through a variety of measures, it is preferred that the code be infrared readable, thus rendering it invisible to the unaided eye. The embodiment of FIG. 10 requires a mechanism capable of vertically interpreting the code (not illustrated) that cannot be copied by conventional means.

Example: Secure Network Based Installation Procedures for Software

Another embodiment of the present invention is the installing of digital information through a communication medium (e.g., a local network, wide area network or public network such as the Internet). Pursuant to this process, an installation program is started. The installation program includes a first step whereby information associated with the destination computer (i.e., the computer onto which the data is to be installed) is queried to collect pre-selected component information. The collection of such data may be effected by a direct query by the program executing on the installation computer, a querying program that resides on the destination computer prior to initiation of the installation process or by execution of an independent program which has been downloaded onto the destination computer and executes on said computer (e.g., Java applets). The information once collected may be sent back to the server computer for generation of the binary key, or alternatively, the binary key may also be generated at the destination computer by such local programs. After generation, a copy of the binary key is either transferred to the destination computer, stored on the installation computer or both.

Once the forensic identifier (i.e., the binary key) has been generated, the installation program continues the installation process. The process may optionally include an encoding step whereby files used by the program to be installed are encoded using an algorithm in combination with the key. The files associated with the computer program are then transferred from the installation computer to the destination computer.

The computer program includes a routine whereby an authentication check may be performed. The routine includes a first step whereby the pre-selected components are queried to obtain component information which is then used to generate the forensic identifier (i.e., the binary key). The routine then retrieves the previously produced binary key from its stored location, compares it to the newly generated key, and based on an authentication assessment, either terminates the executing program or commences an alternative procedure. The authentication assessment will be effected by use of a suitable authentication algorithm in conjunction with the two binary keys. A result that is generated based on a predefined “positive” or “negative” authentication condition. As the authentication routine is (a) integrated as a function within the program, and (b) requires contemporaneous collection of component information to generate the key against which authentication will be measured, it effectively prevents operation of computer programs using files copied from the destination computer.

In the event that a negative authentication result is returned, the process optionally modifies the computer program to permit functionally limited, time limited or frequency-limited operation. For example, in the functionally-limited example, certain functions of the computer program are disabled. In the time-limited example, a period is defined after which the installed program will not operate. In the frequency-limited example, the program may be executed a finite number of times, after which it is disabled and cannot be executed.

Another example of securely installed software involves an authentication process whereby a key stored on server is retrieved during the authentication process and is compared to a key generated during initial execution or use of the data being secured. The vendor of the computer program in this example manages access to the keys, creation of the keys and control over the authentication requirements. For example, one can purchase software, audio and video files, and pictures as well as many other different kinds of digital information through the Internet. When downloaded from the Internet, the digital information is stored the requestor's desired device. The requester of the data initiates contact with the owner of the information. Prior to the downloading of any bits, the server sends out the invention to the requestor's rendering device. At this instant, the requestor's device is probed for unique information that is embedded into the requested information. Once the information is embedded, the server downloads the information to the requester's rendering device for use with that device. Each time a request for access to the information is initiated, an authentication routine is begun and a probing of the system returns a value that is verified against the embedded information.

Example: Secure Music or Motion Picture Distribution

Several examples of application of the invention are described here having particular relevance to the music and motion picture industries. A common element to these scenarios is based on use of an authentication procedure that prevents accurate or comprehensible rendering of the audio or audiovisual work. Common to each example is the use of forensic identifiers in association with the information to be rendered.

Generally, the examples involve a number of common steps. First, a forensic identifier is created that is unique to a specific device that will render the information. Second, the identifier is permanently associated with the work. This can be done both in respect of digitally encoded works as well as works encoded on analog media (e.g., video or audio tape). Third, the physical media or data files comprising the audio or audiovisual work are transferred to the location where they are to be rendered. Fourth, the forensic identifier is recreated prior to or contemporaneously with the rendering of the information, and based on the authentication result, accurate rendering permitted or prevented.

Different ways of producing the forensic identifiers are described above. In addition, with respect to motion picture rendering devices (including motion picture projectors), devices can be used that can generate or have permanently attached thereto forensic identifiers. Such devices can block the accurate projection of the motion picture based on a negative authentication result. In addition, such devices can also remove intentionally inserted distortions in sound or video display if positive authentication results are provided. Such authentication may be one time, sporadic or continuously evaluated. For example, tones may be embedded in the audio track of a motion picture that are deleted by the motion picture projector in conjunction with the added component. Visual distortions in the film similarly can be “filtered out” by such devices. Additional components that perform similar functions can be incorporated into motion picture projectors.

In one example, the forensic identifier after being created is encoded into the audio track of a motion picture. The encoding is effected by embedding tones in various audible or inaudible spectra in a repeating pattern. Devices attached to or used in conjunction with the motion picture projector serve as the source of component information for the generation of the forensic identifier used to perform the authentication. Such devices also decode the audio signals to retrieve the forensic identifier that is to be used in conjunction with the identifier produced from evaluation of the device. The tones may be embedded in the subaudio, suprauadio and audio spectra.

The security of this system can be implemented by various means by which the motion picture cannot be projected. For example, if an invalid authentication result is provided when the motion picture is run, the projector can be disabled by blowing a fuse or triggering an electrical “lock out” function. Alternatively, the projector lamp can be disabled, audio signals not delivered, or any other mechanism by which the projector cannot display the motion picture. In addition, through use of devices, artifacts or distortions introduced into the medium containing the motion picture can be maintained absent a proper authentication result.

Where the motion picture rendering device is a digitally based system, various mechanisms can be employed to prevent the rendering of the motion picture. Examples of such systems include digital video projection units, DVD players, videodisc players and other projection devices that use digital rather than analog encoded information. In these devices, circuits or programmable logic units can be configured to perform the forensic identifier generation step and the authentication steps, either in a single, random or continuous manner. If negative authentication results are provided, the information can be scrambled or altered, or various operational features of the device can be disabled.

Where the motion picture or audio work is encoded and rendered from a digital form, additional security mechanisms are available for use in the invention. Specifically, the data comprising the work can be encoded using an appropriate encoding algorithm in conjunction with a forensic identifier in the form of a binary key. The forensic identifier may be linked to a specific digital video projectors or DVD players or a class of such projectors. The former example is suitable for the controlled distribution of specifically encoded copies of motion pictures that can only be rendered at locations having the specific projector. The latter example is suitable for distribution to a confined class of authorized users, each of which will possess a device having the components needed to provide a positive authentication result pursuant to the invention. In relation to DVDs, the earlier described methods for associating forensic identifiers to media upon which the encoded digital information resides can be employed in conjunction with an additional encoding of said data. The DVD players suitable for this example would include a component that provides the continuous decoding of the encoded motion picture data, using as the forensic identifier the identifier attached to the media.

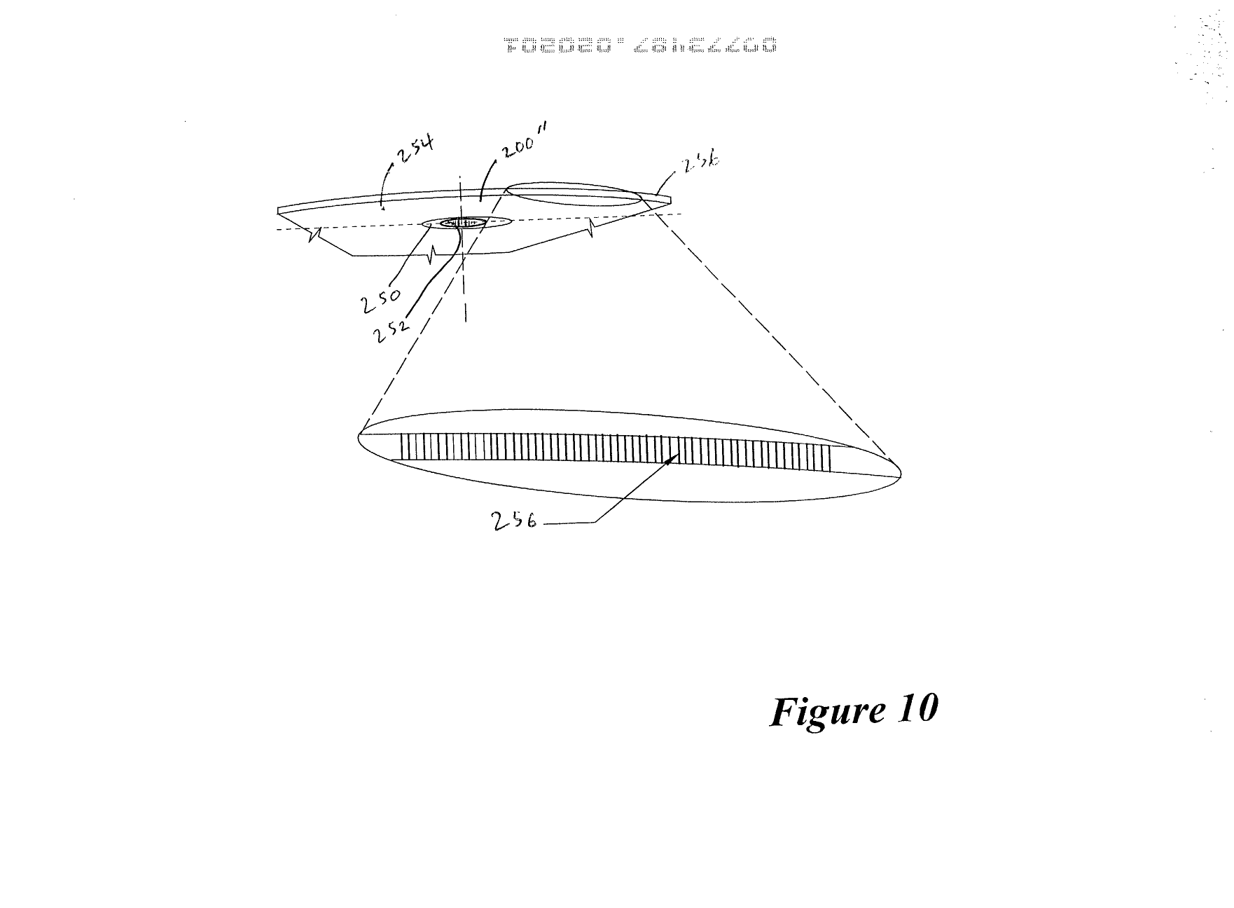

Reference is made to the earlier discussion of FIGS. 1, 2 and 3. FIG. 11 is diagrammatic view of a projector security embodiment of the present invention. The invention incorporates the devices (8, 31) in FIG. 1 and FIG. 2. The projector security embodiment incorporates or embeds the rendering device's (i.e. projector) serial number into the audio frequency (52) of the video. The device (31) is FIG. 2 attempts to locate the device (8) in FIG. 1 on the projector. If the device (8) is absent or is not locatable, then the video's audio frequency is manipulated in a manner to render it unintelligible. For example, if a movie pirate enters the movie theater and records the latest box office hit with a hand-held camcorder, the video's audio frequency contains the serial number that becomes embedded within the copy, thereby identifying the source of the illegal copy.

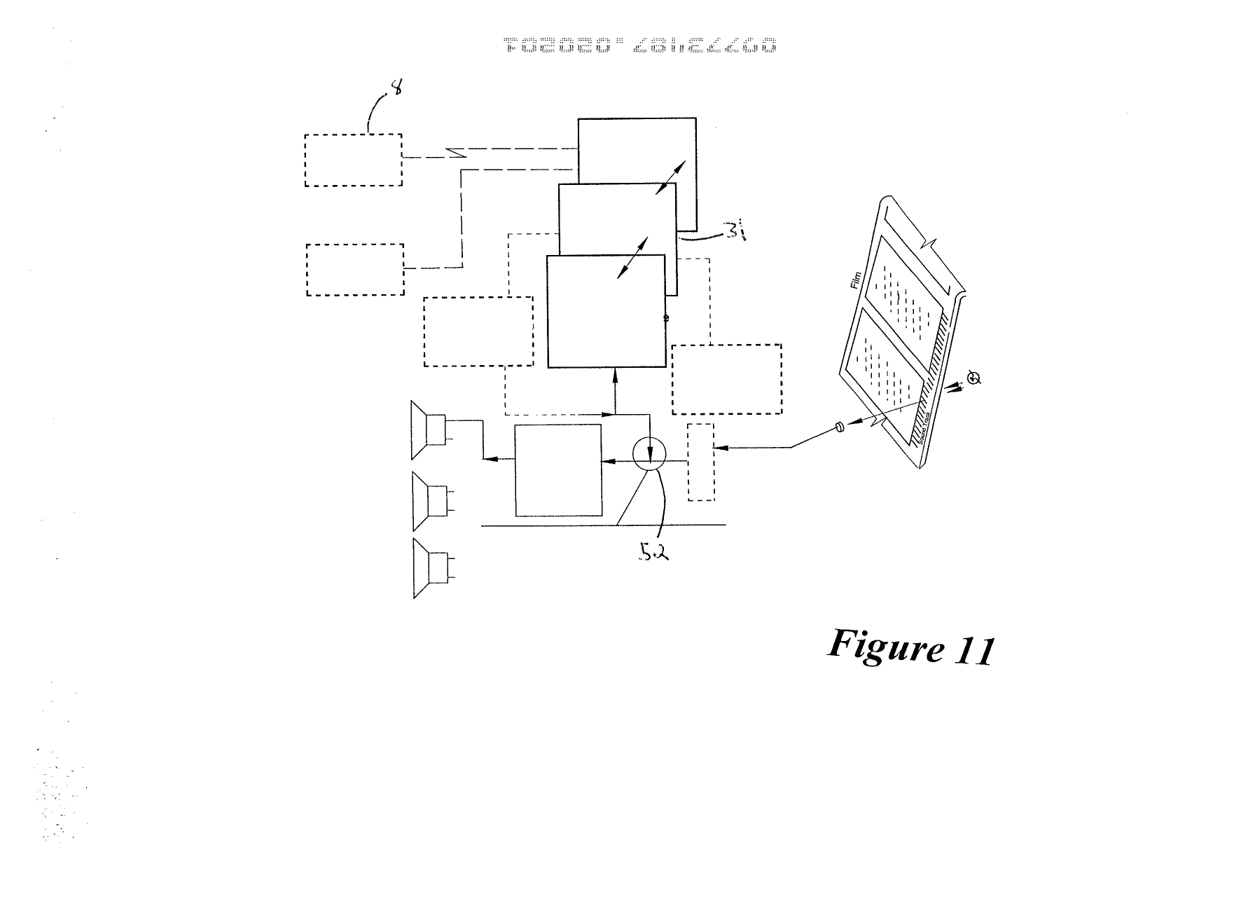

FIG. 12 is a side-elevational view of a system for prohibiting replication of visualization media. The visualization media is placed into a rendering device. In the case of movie, the rendering device is a projector. In this embodiment, the media is projected with a modulated radiant spectrum that is only capable of being seen with the projection lens (54). If the media is not shown through the lens, i.e. the lens is not detected, then the invention takes certain preprogrammed action.

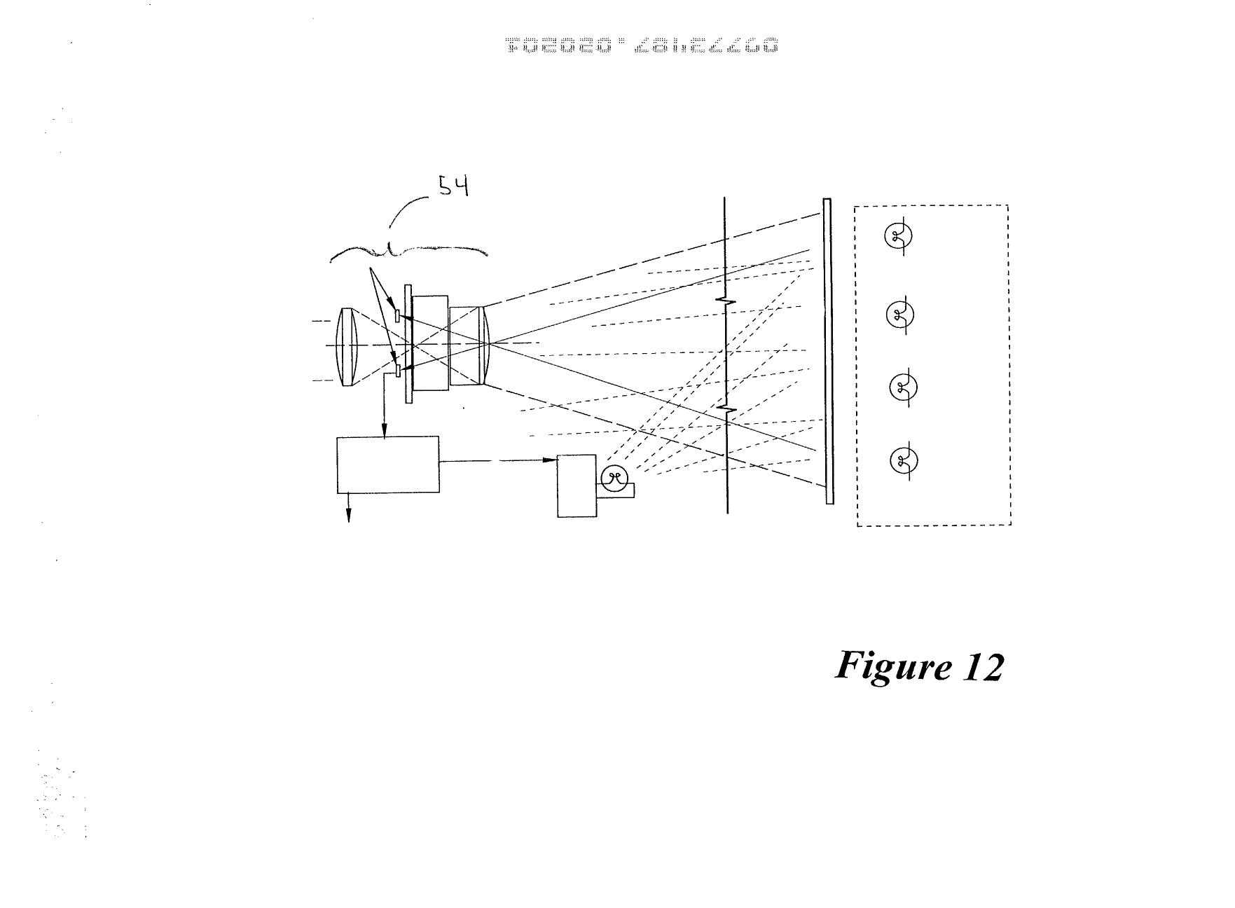

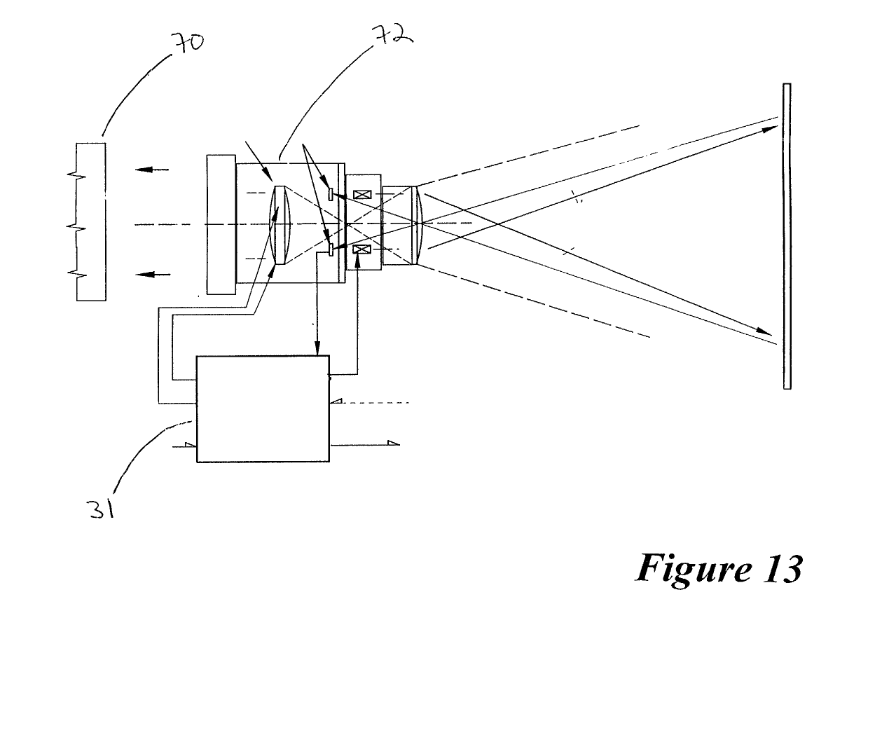

FIG. 13 is a side-elevational view of a system for limiting use of a visualizable media to a specified projection device. In this embodiment, the rendering device, the movie projector (70) is equipped with a lens adapter (72). The movie mandates that the projector use the lens or the media is incapable of being rendered. If the media detects the lens (72), then control codes are transmitted to the lens adapter to enable it to project to the movie in its correct manner. The media is embedded with a device (8). Upon the media being loaded into the projector, the lens adapter, which is incorporated with the device (31), communicates with device (8) to institute a validation routine. If the validation routine returns with a positive response, the control codes are transmitted from the device (31) to enable the lens to show the movie in a viewable format. A negative validation routine results in a number of preprogrammed options. The range from disabling the device to scrambling the movie making it unintelligible for the viewer.

Although the present invention has been described and illustrated in detail, it is to be clearly understood that the same is by way of illustration and example only and is not to be taken by way of limitation, the spirit and scope of the present invention being limited only by the terms of the appended claims.

What is claimed is:

1. A process for securing information in a digital form comprising:
creating an identifier using information obtained from a device capable of rendering the digitized information to be secured;
associating the identifier with the information to be rendered;
securing said digitized information by preventing the rendering of the information if the identity of the device upon which the information is to be rendered is not verified using said identifier.

2. A process according to claim 1 wherein the identifier is a binary key suitable for use in an algorithm that can secure said digitized information.

3. A process according to claim 2, wherein the identifier is produced by evaluating information associated with a specific physical device that can render the secured information and the identifier uniquely identifies said device.

4. A process according to claim 2, wherein the identifier is produced by evaluating information associated with a class of physical devices that can render the secured information and the identifier uniquely identifies said class of devices.

5. The process as set forth in claim 2, wherein the information associated with the specific physical device that is to be used to render the secured information is produced by:
obtaining information representing a physical or functional attribute of at least one component in said physical device which is unique to that component; and
converting said information into a binary key by performing a cyclic redundancy check or other repeatable process on said information.

6. A process according to claim 5, wherein the identifier comprises a binary key of at least 64 bits in length.

7. A process according to claim 6, wherein the information is secured by preventing the rendering of the information by the device on the basis of information produced by a test for authentication of the device using the said binary key and an algorithm suitable for authentication.

8. A process according to claim 6, wherein the information is secured by preventing the operation of the device on the basis of information produced by a test for authentication of the device using the said binary key and an algorithm suitable for authentication.

9. The process as set forth in claim 7 wherein the test for authentication comprises comparing information associated with the data to be rendered with information produced by an evaluation of the device which is to be used to render said data.

10. The process as set forth in claim 9 wherein the evaluation of the device occurs during the process of authentication.

11. The process as set forth in claim 9 wherein the information to be rendered is received by the device in an encoded format, and is unencoded prior to rendering by said device.

12. The process as set forth in claim 9 wherein the information to be rendered is received by the device in an encoded format distinct from a format that the device can use to render said information, and said information is unencoded prior to rendering by said device.

13. The process as set forth in claim 9 wherein the information to be rendered is received by the device in a format the device can render without subsequent transformation.

14. The process as set forth in claim 6 wherein the physical device is a general purpose computer and the component is selected from the group consisting of a bus, a microprocessor, an integrated circuit, a hard drive; a video display circuit, a network interface circuit, a video display card, a network interface card or a circuit located on a peripheral connected to a local bus on said system.

15. A process for securely transferring information in a digital form comprising:
obtaining information to be distributed, wherein the information is in a digital form;
producing a binary key of at least 64 bits using information associated with the device that is to render the information after it has been distributed;
encoding the information by using the unique identifier in combination with an algorithm suitable for encoding such information;
transferring the information to the location at which the device that is to render the information is located;
decoding the information by
producing a binary key by collecting information from the device that is to render the information after receiving the information;
decoding the encoded information using the binary key.

16. The process as set forth in claim 15, wherein the steps of decoding the encoded information are performed incidental to the process of rendering the information.

17. The process as set forth in claim 15, wherein the device used in rendering the information produces the key incidental to the process of decoding and rendering the encoded information.

18. The process as set forth in claim 15, wherein the steps of decoding the encoded information are performed by a distinct device from the device that renders the information.

19. The process as set forth in claim 15, wherein the steps of decoding the encoded information are performed by the device that renders the information.

20. The process as set forth in claim 15, wherein the key is associated with the data containing the encoded information.

21. The process as set forth in claim 15, wherein the key is transferred distinct from the file containing the encoded information.

22. The process as set forth in claim 15, wherein the process further comprises:
segmenting the data to be distributed into one or more blocks;
defining an arbitrary numeric or alphanumeric indicator representing the level of security employed by the distribution process;
producing a data size indicator representing at least the size of the block of data;
producing an encoded data content indicator representing the unsegmented encoded information;
producing an encoded checksum by performing a cyclic redundancy check operation on the file containing the encoded information;
producing a block integrity verifier by performing a cyclic redundancy check operation on a file comprising the security indicator, the size indicator, the encoded data content indicator and the encoded checksum; and
combining the security indicator, the size indicator, the encoded data content indicator, the encoded checksum and the block integrity verifier.

23. A process of installing software in a manner that prevents the unauthorized duplication or use of the software after it has been installed on a specific computer, wherein the process comprises:
during the process of installation of the software onto the computer:
producing a unique identifier using information derived from the physical components of the workstation onto which the software is to be installed;
including the unique identifier into one or more of the files associated with the software as installed;
at the time of initiation of execution of the software by a user after it has been installed;
producing a unique identifier using information derived from the physical components of the workstation onto which the software is to be installed;
comparing the unique identifier with a unique identifier included in one or more of the files associated with the software to executed; and
if the comparison provides a pre-defined negative result based on the unique identifiers, preventing the software from executing.

24. A process for preventing the installation or operation of software other than from a specified physical medium comprising:
prior to encoding data onto a computer-readable medium wherein the data comprises files used to install the software, producing a unique identifier using information associated with the physical structure of the medium;
including the unique identifier in one or more files used in the installation process for the said software;
during the process of installation of the software,
producing a unique identifier using information derived from the physical structure of the medium;
comparing the unique identifier to the unique identifier included in the at least one file used in the installation process for the said software;
if the comparison provides a pre-defined negative result based on the unique identifiers, causing the termination of the installation process.

25. The process as set forth in claim 24, wherein the information is secured by preventing the reading of data from the medium containing the software to be installed.

26. The process as set forth in claim 24, wherein the physical structure of the medium has been intentionally altered to incorporate a pre-defined arbitrary identifier.

27. The process as set forth in claim 26, wherein the medium is a floppy disk and the alteration is effected by permanently altering sectors of the disk to encode on said disk the pre-defined arbitrary identifier.

28. The process as set forth in claim 27, wherein the permanent alteration of said disk is effected by physically altering magnetic oxide residues on said disk which do not correspond to recorded bits on said disk.

29. The process as set forth in claim 28, wherein said permanent alteration is effected by using a laser to destroy said magnetic oxide residues.

30. A process of installing software across a network in a manner that prevents the unauthorized duplication or use of the software after it has been installed on a specific computer comprising:
initiating an installation process for installing software onto a computer from a server computer using a network;
producing a unique identifier using information derived from at least one physical component of the computer upon which the software is to be installed;
including the unique identifier in at least one file associated with the software to be installed, wherein the absence of said file prevents operation of the software;
transferring the files including at least the said file containing the included identifier to the computer upon which the software is to be installed;
at the time of execution of the software after it has been installed,
producing a unique identifier using information derived from at least one physical component of the computer upon which the software is to be installed;
comparing the unique identifier to the unique identifier embedded in the said at least one file associated with the software;
if the comparison provides a pre-defined negative result based on the unique identifiers, preventing the software from executing, preventing the operation of the software.

31. The process as set forth in claim 30 wherein the identifier is produced on the server in response to said information.

32. The process as set forth in any one of claim 23, 24 or 30, wherein the process for producing the unique identifier further comprises:
assigning an arbitrary identifier that uniquely identifies the producer of the software, the software product to be installed or the two factors in combination;
producing a binary key by using the arbitrary identifier and information derived from at least one physical component of the computer upon which the software is to be installed in an algorithm that produces an exclusive and repeatable result.

33. The process according to any one of claim 14, 15, 22, 23, 24 or 30, wherein the information used to produce the key comprises an identifier permanently and uniquely associated with said component.

34. The process as set forth in claim 33, wherein the information unique to the component comprises descriptive data related to one or more physical or operational attributes of a hard drive.

35. The process as set forth in claim 33, wherein the information is selected from the group consisting of one or more of the following: the drive ATA information block, the drive partition table, the drive interface type, the drive data capacity in formatted state, the drive capacity in unformatted state, the number of cylinders on the drive, the number of sectors on each track, the diagnostic cylinder number, the drive defect map and the effective data transfer speed of the drive in bytes per second.

36. The process as set forth in claim 33, wherein the information unique to the component comprises one or more of the following: the system speed index; the DRAM refresh clocking value associated with the system board and BIOS of the computer; a unique serial number associated with the microprocessor; the information stored in a CMOS memory address above 16base10; the ROM table for the system; information obtained by parsing interrupt 1Ah of the system board; information obtained by parsing interrupt 15h of the system board; information representing the access time of a video port in the system in combination with the location of said video port on said system; information unique to specific circuits, adapters or devices attached to or embedded within the system, such as a network interface or an audio interface card.

37. The process as set forth in claim 33, wherein the identifier is produced from information associated with at least two components which is combined prior to being used to generate the binary key.

38. The process as set forth in claim 33, wherein the identifier is produced from information associated with at least three components which is combined prior to being used to generate the binary key.

39. The process as set forth in claim 33, wherein the identifier is produced from information associated with at least four components which is combined prior to being used to generate the binary key.

40. The process as set forth in claim 33, wherein the identifier is produced from information associated with at least five components which is combined prior to being used to generate the binary key.

41. The process as set forth in claim 33, wherein the identifier is produced from information associated with at least six components which is combined prior to being used to generate the binary key.

42. The process as set forth in claim 33, wherein the identifier is produced from information associated with at least seven components which is combined prior to being used to generate the binary key.

43. A process for securely distributing information representing an audio or audiovisual work comprising:
producing a binary key using information derived from at least one physical component of a device capable of rendering the work;
associating with the information representing the audio or audiovisual work the binary key produced;
distributing the information to the location at which the information is to be rendered;
prior to or during the rendering of the information on a device capable of rendering said information,
producing a binary key using information derived from at least one physical component of the device;
retrieving from said information the binary key associated with said information;
comparing the binary key extracted from said information with the binary key produced using information from the device;
preventing the rendering of the information if the binary key associated with the information is not identical to the binary key produced using the device.

44. The process as set forth in claim 43, wherein the device is selected from the group consisting of a general purpose computer, a special purpose computer, a DVD player, a CD player, a motion picture projector or a device that comprises a video display unit in combination with circuitry capable of rendering an audiovisual work in a digital form.

45. The process as set forth in claim 44, wherein the component is a device attached to the lens of a motion picture projector and the device comprises a circuit and elements that are capable of altering or preventing the display of images by the projector.

46. The process as set forth in any one of claim 43, 44 or 45, which further comprises:
producing a binary key using attributes of a device that can be attached to the lens of a motion picture projector;
encoding the binary key into the information as encoded onto a medium suitable for distribution and use in motion picture rendering of audiovisual works;
during the rendering of said information, extracting from said information the binary key;
producing a binary key using information from a component attached to the lens of a motion picture projector; and
comparing the binary key produced from said component to the binary key extracted from the information,

47. The process as set forth in any one of claim 44 or 45, wherein the binary key is encoded onto the audio track of the audiovisual work.

48. The process as set forth in claim 47, wherein the binary key is encoded by placing an audio signal into one or more spectrums of the audio track of the audiovisual work.

49. The process as set forth in claim 48, wherein the binary key is encoded into the audio track of the audiovisual work using tones in sub-audio, supra audio and audio frequencies.

50. The process as set forth in any one of claim 43, 44, 45, 46, 47, 48 or 49, wherein the rendering is prevented by blocking or altering the projection of images through the lens of a motion picture projector.

51. The process as set forth in any one of claim 43, 44, 45, 46, 47, 48 or 49, wherein the rendering is prevented by disabling the operation of the motion picture projector.

52. The process as set forth in any one of claim 43, 44, 45, 46, 47, 48 or 49, wherein the rendering is prevented by blocking the supply of electricity to the device that is to render the information.

53. The process as set forth in any one of claim 43, 44, 45, 46, 47, 48 or 49, wherein the rendering is prevented by blocking the transmission of a video signal to a display.

54. A process of preventing the unauthorized rendering of information originally stored on an optically readable medium, wherein the process comprises:
defining a unique identifier for the information to be secured;
incorporating a unique physical media identifier into the physical structure of the optically readable medium;
producing a binary key of at least 128 bits using the unique identifier for the information to be secured and the physical media identifier;
encoding the binary key on the optical medium in a form readable by a device that can render the information;
prior to or during the rendering of the information by the device;
causing the device to evaluate the physical media to detect the binary key and the unique physical media identifier;
evaluating the information obtained by the detection step to determine if the information to be rendered is encoded on the optical medium having the unique physical media identifier;
if the evaluation step provides a pre-defined negative result, preventing the device from rendering the encoded information.

55. The process as set forth in claim 54, wherein the encoding of the binary key and the unique physical media identifier is effected by physically altering a portion of the optical medium outside that used to store data representing information to be rendered.

56, The process as set forth in claim 54 wherein the device comprises a CD-player, a DVD-player or a videodisc player.

57. The process as set forth in claim 55, wherein the binary key is encoded on the surface of the optical medium using a physical structure distinct from that used to encode data representing information to be rendered on said structure.

58. The process as set forth in claim 57, wherein the data as encoded in the physical structure is to be read by a laser at an angle other than 90 degrees.

59. The process as set forth in claim 55, wherein the device detects the binary key and the unique physical media identifier by evaluating a circuit attached to or embedded within the optical medium.

60. The process as set forth in claim 55, wherein the unique physical media identifier and the binary key are stored in a circuit embedded within the optical medium and the device reads the information in said circuit by activating the circuit upon contact with the device.

61. The process as set forth in claim 55, wherein the unique physical media identifier and the binary key are stored in a circuit attached to the spindle hole of the optical medium.

62. The process as set forth in claim 55, wherein the binary key and the unique physical media identifier are encoded in the inner side surface of the spindle hole of the optical medium in a form that may be read by optical or magnetic means located within the device that is to render the encoded information.

63. A process for preventing the unauthorized rendering of a audiovisual or audio work in a digital form, wherein the process comprises:
producing a binary key using information derived from at least one physical component of a device capable of rendering the work;
encoding the information representing the audio or audiovisual work using an algorithm in conjunction with the binary key so produced;
distributing the information to the location at which the information is to be rendered;
prior to or during the rendering of the information on a device capable of rendering said information,
producing a binary key using information derived from at least one physical component of the device;
decoding the encoded information using the binary key produced;
rendering the decoded information.

64. The process according to claim 63, wherein the decoding of the encoded information is performed contemporaneously with the rendering of the information.

65. The process according to claim 64, wherein the binary key is unique to a specific device.

66. The process according to claim 64, wherein the binary key is unique to a class of devices that share a commonly identifiable component that is used to generate said key.
